(19) United States
(12) Patent Application Publication
(10) Pub. No.: US 2023/0239853 A1
(43) Pub. Date: Jul. 27, 2023

(54) METHOD AND APPARATUS FOR UPLINK/DOWNLINK TRANSMISSION AND RECEPTION BASED ON BEAM LINKAGE STATE IN WIRELESS COMMUNICATION SYSTEM

(71) Applicant: LG ELECTRONICS INC., Seoul (KR)

(72) Inventors: Jaehoon CHUNG, Seoul (KR); Jiwon KANG, Seoul (KR); Seongwon GO, Seoul (KR); Kyuseok KIM, Seoul (KR)

(21) Appl. No.: 18/009,283

(22) PCT Filed: Aug. 4, 2021
(86) PCT No.: PCT/KR2021/010205

§ 371 Date: Dec. 8, 2022

(30) Foreign Application Priority Data
Aug. 4, 2020 (KR) 10-2020-0097686

(51) Int. Cl. H04W 72/044

(52) U.S. Cl. CPC H04W 72/046

(57) ABSTRACT

Disclosed are a method and an apparatus for performing uplink/downlink transmission and reception on the basis of a beam linkage state in a wireless communication system. A method for performing uplink transmission or downlink reception by a terminal in a wireless communication system according to an embodiment of the present disclosure may comprise the steps of: receiving configuration information for a first beam linkage state (BLS) for a first resource and a second BLS for a second resource from a base station, wherein each of the first and second BLSs includes information on a mapping relationship between reference transmission and reception and one or more target transmissions and receptions; receiving, from the base station, reference spatial parameter indication information for the reference transmission and reception with regard to the first resource; and performing the uplink transmission or the downlink reception through the second resource, on the basis of a target spatial parameter for specific target transmission and reception among the one or more target transmissions and receptions, wherein the target spatial parameter may be determined on the basis of the reference spatial parameter.

### TECHNICAL FIELD

The present disclosure relates to a wireless communication system, and in more detail, relates to a method and an apparatus of performing uplink/downlink transmission or reception based on a beam linkage state in a wireless communication system.

### BACKGROUND ART

A mobile communication system has been developed to provide a voice service while guaranteeing mobility of users. However, a mobile communication system has extended even to a data service as well as a voice service, and currently, an explosive traffic increase has caused shortage of resources and users have demanded a faster service, so a more advanced mobile communication system has been required.

The requirements of a next-generation mobile communication system at large should be able to support accommodation of explosive data traffic, a remarkable increase in a transmission rate per user, accommodation of the significantly increased number of connected devices, very low End-to-End latency and high energy efficiency. To this end, a variety of technologies such as Dual Connectivity, Massive Multiple Input Multiple Output (Massive MIMO), In-band Full Duplex, Non-Orthogonal Multiple Access (NOMA), Super wideband Support, Device Networking, etc. have been researched.

### DISCLOSURE

### Technical Problem

A technical problem of the present disclosure is to provide a method and a device of performing uplink/downlink transmission or reception based on a beam linkage state in a wireless communication system.

An additional technical problem of the present disclosure is to provide a method and a device of transmitting and receiving an uplink/a downlink based on a beam linkage state for a terminal that multiple cells/bandwidth parts are configured in a wireless communication system.

An additional technical problem of the present disclosure is to provide a method and a device of determining a spatial parameter which will be applied to target transmission or reception associated with reference transmission or reception by a beam linkage state for a terminal that multiple cells/bandwidth parts are configured in a wireless communication system.

The technical objects to be achieved by the present disclosure are not limited to the above-described technical objects, and other technical objects which are not described herein will be clearly understood by those skilled in the pertinent art from the following description.

### Technical Solution

A method of performing uplink transmission or downlink reception by a terminal in a wireless communication system according to an aspect of the present disclosure: includes receiving from a base station configuration information on a first beam linkage state (BLS) for a first resource and a second BLS for a second resource, wherein each of the first and second BLS includes information on a mapping relation between reference transmission or reception and at least one target transmission or reception; receiving from the base station reference spatial parameter indication information for the reference transmission or reception for the first resource; and based on a target spatial parameter for specific target transmission or reception among the at least one target transmission or reception, performing the uplink transmission or the downlink reception on the second resource, and the target spatial parameter may be determined based on the reference spatial parameter.

A method of performing downlink transmission or uplink reception by a base station in a wireless communication system according to an additional aspect of the present disclosure: includes transmitting to a terminal configuration information on a first beam linkage state (BLS) for a first resource and a second BLS for a second resource, wherein each of the first and second BLS includes information on a mapping relation between reference transmission or reception and at least one target transmission or reception; transmitting to the terminal reference spatial parameter indication information for the reference transmission or reception for the first resource; and performing the downlink transmission or the uplink reception on the second resource, and the downlink transmission or the uplink reception on the second resource may be received or transmitted by the terminal based on a target spatial parameter for specific target transmission or reception among the at least one target transmission or reception and the target spatial parameter may be determined based on the reference spatial parameter.

### Technical Effects

According to the present disclosure, a method and a device of performing uplink/downlink transmission or reception based on a beam linkage state in a wireless communication system may be provided.

According to the present disclosure, a method and a device of transmitting and receiving an uplink/a downlink based on a beam linkage state for a terminal that multiple cells/bandwidth parts are configured in a wireless communication system may be provided.

According to the present disclosure, a method and a device of determining a spatial parameter which will be applied to target transmission or reception associated with reference transmission or reception by a beam linkage state for a terminal that multiple cells/bandwidth parts are configured in a wireless communication system are provided.

Effects achievable by the present disclosure are not limited to the above-described effects, and other effects which are not described herein may be clearly understood by those skilled in the pertinent art from the following description.

### DESCRIPTION OF DIAGRAMS

Accompanying drawings included as part of detailed description for understanding the present disclosure provide embodiments of the present disclosure and describe technical features of the present disclosure with detailed description.

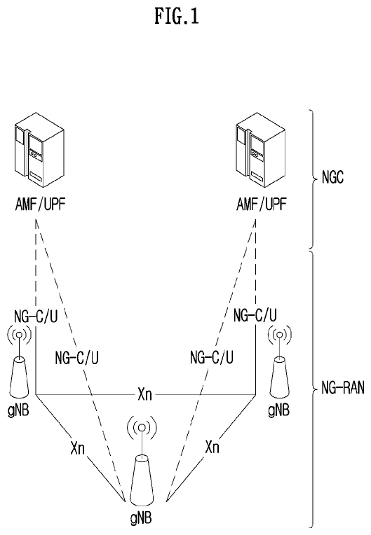

FIG. 1 illustrates a structure of a wireless communication system to which the present disclosure may be applied.

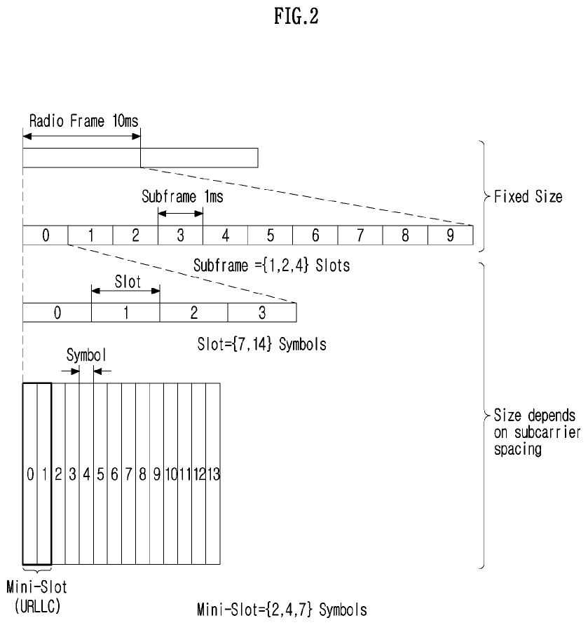

FIG. 2 illustrates a frame structure in a wireless communication system to which the present disclosure may be applied.

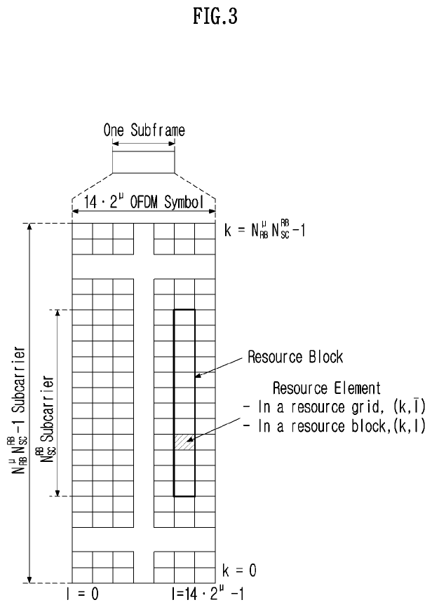

FIG. 3 illustrates a resource grid in a wireless communication system to which the present disclosure may be applied.

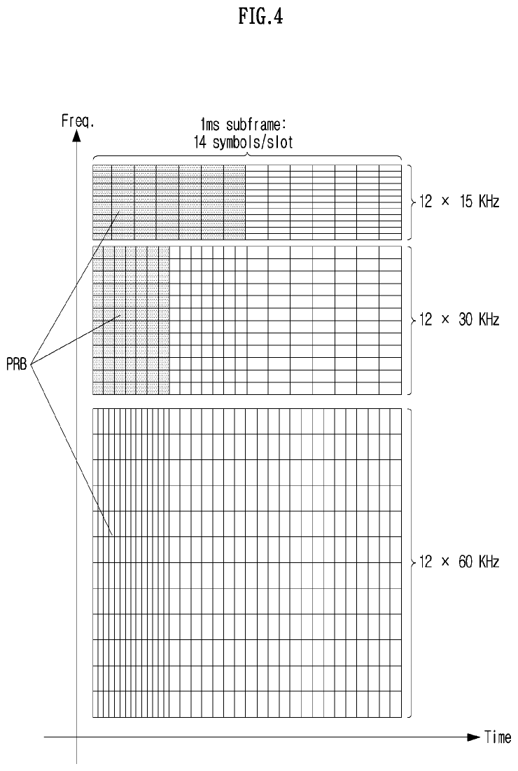

FIG. 4 illustrates a physical resource block in a wireless communication system to which the present disclosure may be applied.

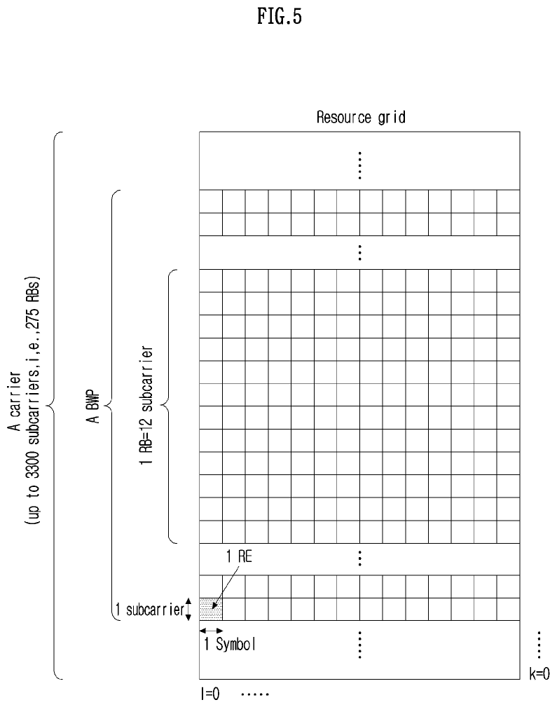

FIG. 5 illustrates a slot structure in a wireless communication system to which the present disclosure may be applied.

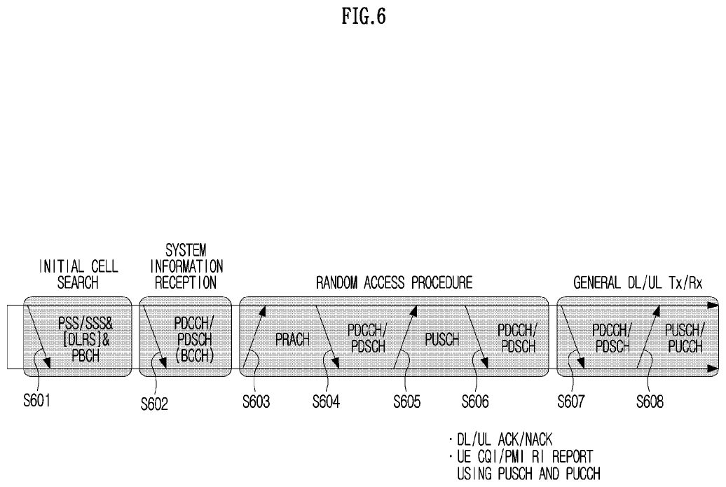

FIG. 6 illustrates physical channels used in a wireless communication system to which the present disclosure may be applied and a general signal transmission and reception method using them.

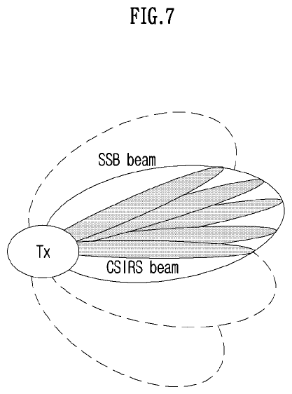

FIG. 7 is a diagram which illustrates a downlink beam management operation in a wireless communication system to which the present disclosure may be applied.

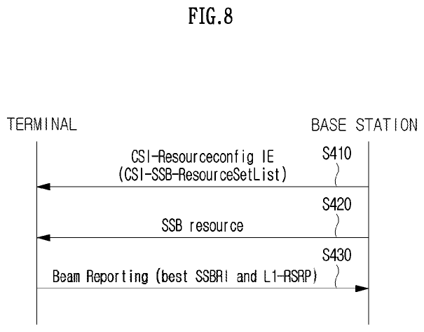

FIG. 8 is a diagram which illustrates a downlink beam management procedure using SSB in a wireless communication system to which the present disclosure may be applied.

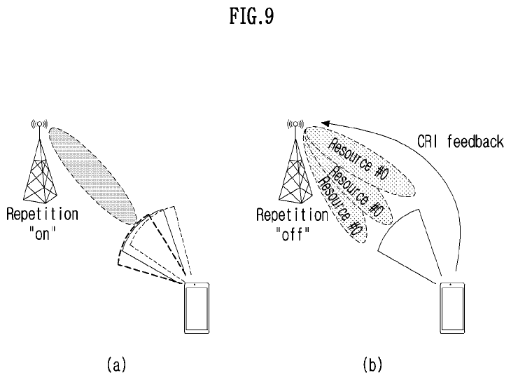

FIG. 9 is a diagram which illustrates a downlink beam management operation using CSI-RS in a wireless communication system to which the present disclosure may be applied.

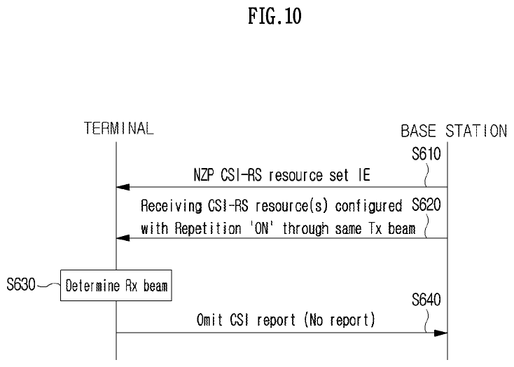

FIG. 10 is a diagram which illustrates an Rx beam determination process of a terminal in a wireless communication system to which the present disclosure may be applied.

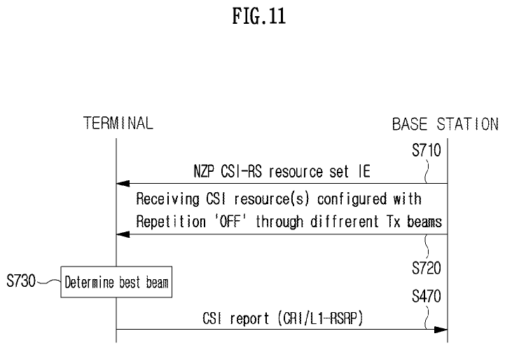

FIG. 11 is a diagram which illustrates a Tx beam determination process of a base station in a wireless communication system to which the present disclosure may be applied.

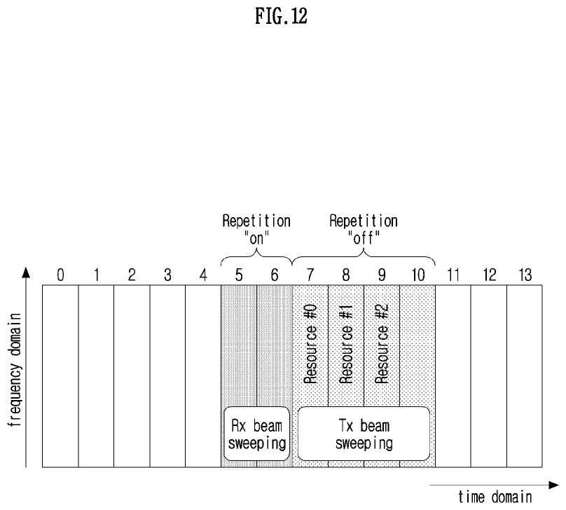

FIG. 12 is a diagram which illustrates resource allocation in a time and frequency domain related to a downlink beam management operation in a wireless communication system to which the present disclosure may be applied.

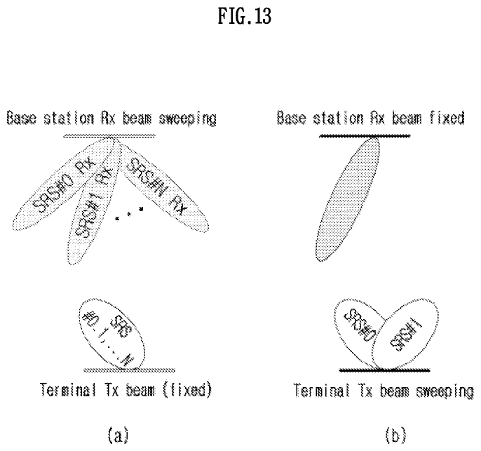

FIG. 13 is a diagram which illustrates an uplink beam management operation using SRS in a wireless communication system to which the present disclosure may be applied.

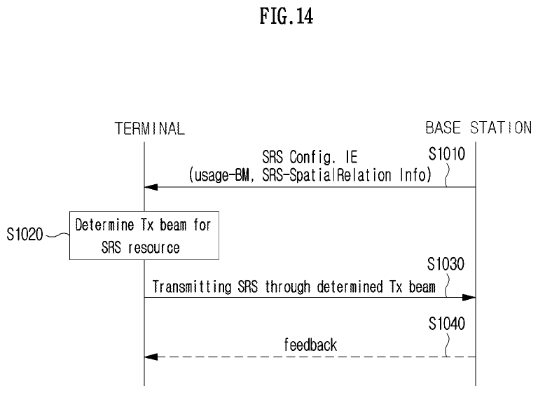

FIG. 14 is a diagram which illustrates an uplink beam management procedure in a wireless communication system to which the present disclosure may be applied.

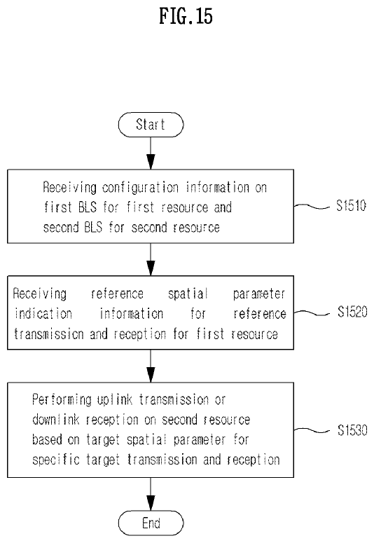

FIG. 15 is a flow chart for describing a method in which a terminal performs uplink transmission or downlink reception based on a beam linkage state according to the present disclosure.

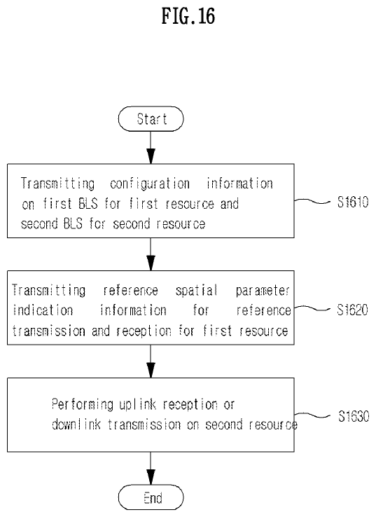

FIG. 16 is a flow chart for describing a method in which a base station performs uplink reception or downlink transmission based on a beam linkage state according to the present disclosure.

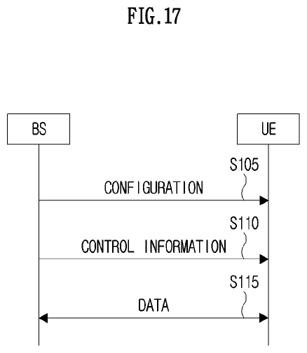

FIG. 17 is a diagram for illustrating a signaling process according to an embodiment of the present disclosure.

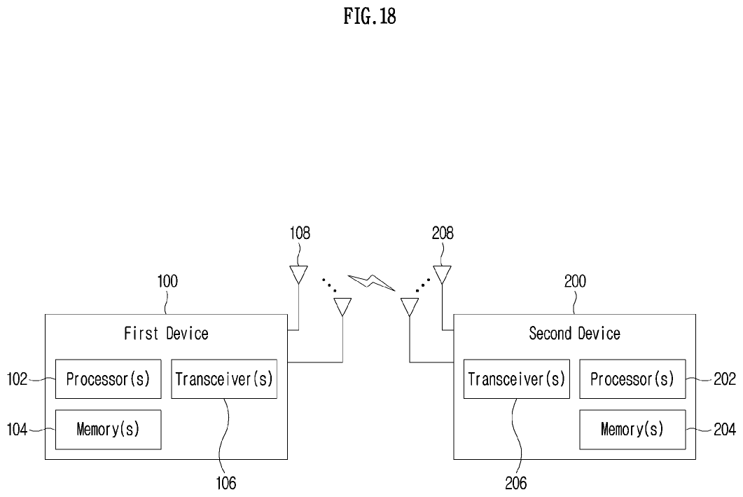

FIG. 18 is a diagram which illustrates a block diagram of a wireless communication device according to an embodiment of the present disclosure.

### BEST MODE

Hereinafter, embodiments according to the present disclosure will be described in detail by referring to accompanying drawings. Detailed description to be disclosed with accompanying drawings is to describe exemplary embodiments of the present disclosure and is not to represent the only embodiment that the present disclosure may be implemented. The following detailed description includes specific details to provide complete understanding of the present disclosure. However, those skilled in the pertinent art knows that the present disclosure may be implemented without such specific details.

In some cases, known structures and devices may be omitted or may be shown in a form of a block diagram based on a core function of each structure and device in order to prevent a concept of the present disclosure from being ambiguous.

In the present disclosure, when an element is referred to as being “connected”, “combined” or “linked” to another element, it may include an indirect connection relation that yet another element presents therebetween as well as a direct connection relation. In addition, in the present disclosure, a term, “include” or “have”, specifies the presence of a mentioned feature, step, operation, component and/or element, but it does not exclude the presence or addition of one or more other features, stages, operations, components, elements and/or their groups.

In the present disclosure, a term such as “first”, “second”, etc. is used only to distinguish one element from other element and is not used to limit elements, and unless otherwise specified, it does not limit an order or importance, etc. between elements. Accordingly, within a scope of the present disclosure, a first element in an embodiment may be referred to as a second element in another embodiment and likewise, a second element in an embodiment may be referred to as a first element in another embodiment.

A term used in the present disclosure is to describe a specific embodiment, and is not to limit a claim. As used in a described and attached claim of an embodiment, a singular form is intended to include a plural form, unless the context clearly indicates otherwise. A term used in the present disclosure, “and/or”, may refer to one of related enumerated items or it means that it refers to and includes any and all possible combinations of two or more of them. In addition, “/” between words in the present disclosure has the same meaning as “and/or”, unless otherwise described.

The present disclosure describes a wireless communication network or a wireless communication system, and an operation performed in a wireless communication network may be performed in a process in which a device (e.g., a base station) controlling a corresponding wireless communication network controls a network and transmits or receives a signal, or may be performed in a process in which a terminal associated to a corresponding wireless network transmits or receives a signal with a network or between terminals.

In the present disclosure, transmitting or receiving a channel includes a meaning of transmitting or receiving information or a signal through a corresponding channel. For example, transmitting a control channel means that control information or a control signal is transmitted through a control channel. Similarly, transmitting a data channel means that data information or a data signal is transmitted through a data channel.

Hereinafter, a downlink (DL) means a communication from a base station to a terminal and an uplink (UL) means a communication from a terminal to a base station. In a downlink, a transmitter may be part of a base station and a receiver may be part of a terminal. In an uplink, a transmitter may be part of a terminal and a receiver may be part of a base station. A base station may be expressed as a first communication device and a terminal may be expressed as a second communication device. A base station (BS) may be substituted with a term such as a fixed station, a Node B, an eNB (evolved-NodeB), a gNB (Next Generation NodeB), a BTS (base transceiver system), an Access Point (AP), a Network (5G network), an AI (Artificial Intelligence) system/module, an RSU (road side unit), a robot, a drone (UAV: Unmanned Aerial Vehicle), an AR (Augmented Reality) device, a VR (Virtual Reality) device, etc. In addition, a terminal may be fixed or mobile, and may be substituted with a term such as a UE (User Equipment), an MS (Mobile Station), a UT (user terminal), an MSS (Mobile Subscriber Station), an SS(Subscriber Station), an AMS (Advanced Mobile Station), a WT (Wireless terminal), an MTC (Machine-Type Communication) device, an M2M (Machine-to-Machine) device, a D2D (Device-to-Device) device, a vehicle, an RSU (road side unit), a robot, an AI (Artificial Intelligence) module, a drone (UAV: Unmanned Aerial Vehicle), an AR (Augmented Reality) device, a VR (Virtual Reality) device, etc.

The following description may be used for a variety of radio access systems such as CDMA, FDMA, TDMA, OFDMA, SC-FDMA, etc. CDMA may be implemented by a wireless technology such as UTRA (Universal Terrestrial Radio Access) or CDMA2000. TDMA may be implemented by a radio technology such as GSM (Global System for Mobile communications)/GPRS (General Packet Radio Service)/EDGE (Enhanced Data Rates for GSM Evolution). OFDMA may be implemented by a radio technology such as IEEE 802.11(Wi-Fi), IEEE 802.16(WiMAX), IEEE 802-20, E-UTRA (Evolved UTRA), etc. UTRA is a part of a UMTS (Universal Mobile Telecommunications System). 3GPP (3rd Generation Partnership Project) LTE (Long Term Evolution) is a part of an E-UMTS (Evolved UMTS) using E-UTRA and LTE-A (Advanced)/LTE-A pro is an advanced version of 3GPP LTE. 3GPP NR(New Radio or New Radio Access Technology) is an advanced version of 3GPP LTE/LTE-A/LTE-A pro.

To clarify description, it is described based on a 3GPP communication system (e.g., LTE-A, NR), but a technical idea of the present disclosure is not limited thereto. LTE means a technology after 3GPP TS (Technical Specification) 36.xxx Release 8. In detail, an LTE technology in or after 3GPP TS 36.xxx Release 10 is referred to as LTE-A and an LTE technology in or after 3GPP TS 36.xxx Release 13 is referred to as LTE-A pro. 3GPP NR means a technology in or after TS 38.xxx Release 15. LTE/NR may be referred to as a 3GPP system. “xxx” means a detailed number for a standard document. LTE/NR may be commonly referred to as a 3GPP system. For a background art, a term, an abbreviation, etc. used to describe the present disclosure, matters described in a standard document disclosed before the present disclosure may be referred to. For example, the following document may be referred to.

For 3GPP LTE, TS 36.211 (physical channels and modulation), TS 36.212 (multiplexing and channel coding), TS 36.213 (physical layer procedures), TS 36.300 (overall description), TS 36.331 (radio resource control) may be referred to.

For 3GPP NR, TS 38.211 (physical channels and modulation), TS 38.212 (multiplexing and channel coding), TS 38.213 (physical layer procedures for control), TS 38.214 (physical layer procedures for data), TS 38.300 (NR and NG-RAN(New Generation-Radio Access Network) overall description), TS 38.331 (radio resource control protocol specification) may be referred to.

Abbreviations of terms which may be used in the present disclosure is defined as follows.

BM: beam management

CQI: Channel Quality Indicator

CRI: channel state information—reference signal resource indicator

CSI: channel state information

CSI-IM: channel state information—interference measurement

CSI-RS: channel state information—reference signal

DMRS: demodulation reference signal

FDM: frequency division multiplexing

FFT: fast Fourier transform

IFDMA: interleaved frequency division multiple access

IFFT: inverse fast Fourier transform

L1-RSRP: Layer 1 reference signal received power

L1-RSRQ: Layer 1 reference signal received quality

MAC: medium access control

NZP: non-zero power

OFDM: orthogonal frequency division multiplexing

PDCCH: physical downlink control channel

PDSCH: physical downlink shared channel

PMI: precoding matrix indicator

RE: resource element

RI: Rank indicator

RRC: radio resource control

RSSI: received signal strength indicator

Rx: Reception

QCL: quasi co-location

SINR: signal to interference and noise ratio

SSB (or SS/PBCH block): Synchronization signal block (including PSS (primary synchronization signal), SSS (secondary synchronization signal) and PBCH (physical broadcast channel))

TDM: time division multiplexing

TRP: transmission and reception point

TRS: tracking reference signal

Tx: transmission

UE: user equipment

ZP: zero power

Overall System

As more communication devices have required a higher capacity, a need for an improved mobile broadband communication compared to the existing radio access technology (RAT) has emerged. In addition, massive MTC (Machine Type Communications) providing a variety of services anytime and anywhere by connecting a plurality of devices and things is also one of main issues which will be considered in a next-generation communication. Furthermore, a communication system design considering a service/a terminal sensitive to reliability and latency is also discussed. As such, introduction of a next-generation RAT considering eMBB (enhanced mobile broadband communication), mMTC (massive MTC), URLLC (Ultra-Reliable and Low Latency Communication), etc. is discussed and, for convenience, a corresponding technology is referred to as NR in the present disclosure. NR is an expression which represents an example of a 5G RAT.

A new RAT system including NR uses an OFDM transmission method or a transmission method similar to it. A new RAT system may follow OFDM parameters different from OFDM parameters of LTE. Alternatively, a new RAT system follows a numerology of the existing LTE/LTE-A as it is, but may support a wider system bandwidth (e.g., 100 MHz). Alternatively, one cell may support a plurality of numerologies. In other words, terminals which operate in accordance with different numerologies may coexist in one cell.

A numerology corresponds to one subcarrier spacing in a frequency domain. As a reference subcarrier spacing is scaled by an integer N, a different numerology may be defined.

FIG. 1 illustrates a structure of a wireless communication system to which the present disclosure may be applied.

In reference to FIG. 1, NG-RAN is configured with gNBs which provide a control plane (RRC) protocol end for a NG-RA (NG-Radio Access) user plane (i.e., a new AS (access stratum) sublayer/PDCP (Packet Data Convergence Protocol)/RLC(Radio Link Control)/MAC/PHY) and UE. The gNBs are interconnected through a Xn interface. The gNB, in addition, is connected to an NGC(New Generation Core) through an NG interface. In more detail, the gNB is connected to an AMF (Access and Mobility Management Function) through an N2 interface, and is connected to a UPF (User Plane Function) through an N3 interface.

FIG. 2 illustrates a frame structure in a wireless communication system to which the present disclosure may be applied.

A NR system may support a plurality of numerologies. Here, a numerology may be defined by a subcarrier spacing and a cyclic prefix (CP) overhead. Here, a plurality of subcarrier spacings may be derived by scaling a basic (reference) subcarrier spacing by an integer N (or, p). In addition, although it is assumed that a very low subcarrier spacing is not used in a very high carrier frequency, a used numerology may be selected independently from a frequency band. In addition, a variety of frame structures according to a plurality of numerologies may be supported in a NR system.

Hereinafter, an OFDM numerology and frame structure which may be considered in a NR system will be described. A plurality of OFDM numerologies supported in a NR system may be defined as in the following Table 1.

TABLE 1

| μ | Δf = 2^{μ} · 15 [kHz] | CP |
|---|---|---|
| 0 | 15 | Normal |
| 1 | 30 | Normal |
| 2 | 60 | Normal, Extended |
| 3 | 120 | Normal |
| 4 | 240 | Normal |

NR supports a plurality of numerologies (or subcarrier spacings (SCS)) for supporting a variety of 5G services. For example, when a SCS is 15 kHz, a wide area in traditional cellular bands is supported, and when a SCS is 30 kHz/60 kHz, dense-urban, lower latency and a wider carrier bandwidth are supported, and when a SCS is 60 kHz or higher, a bandwidth wider than 24.25 GHz is supported to overcome a phase noise. An NR frequency band is defined as a frequency range in two types (FR1, FR2). FR1, FR2 may be configured as in the following Table 2. In addition, FR2 may mean a millimeter wave (mmW).

TABLE 2

| Frequency Range | Corresponding frequency | Subcarrier |
|---|---|---|
| designation | range | Spacing |
| FR1 | 410 MHz-7125 MHz | 15, 30, 60 kHz |
| FR2 | 24250 MHz-52600 MHz | 60, 120, 240 kHz |

Regarding a frame structure in an NR system, a size of a variety of fields in a time domain is expresses as a multiple of a time unit of T_{c}=1/(Δfₘₐₓ·N_{f}). Here, Δfₘₐₓ is 480·103 Hz and N_{f} is 4096. Downlink and uplink transmission is configured (organized) with a radio frame having a duration of T_{f}=1/(ΔfₘₐₓN_{f}/100)·T_{c}=10 ms. Here, a radio frame is configured with 10 subframes having a duration of T_{sf}=(ΔfₘₐₓN_{f}/1000)·T_{c}=1 ms, respectively. In this case, there may be one set of frames for an uplink and one set of frames for a downlink. In addition, transmission in an uplink frame No. i from a terminal should start earlier by T_{TA}=(N_{TA}+N_{TA,offset})T_{c} than a corresponding downlink frame in a corresponding terminal starts. For a subcarrier spacing configuration μ, slots are numbered in an increasing order of nₛ^{μ}∈{0, . . . , Nₛₗₒₜ^{subframe,μ}−1} in a subframe and are numbered in an increasing order of n_{s,f}^{μ}∈{0, . . . , Nₛₗₒₜ^{frame,μ}−1} in a radio frame. One slot is configured with N_{symb}^{slot} consecutive OFDM symbols and N_{symb}^{slot} is determined according to CP. A start of a slot nₛ^{μ} in a subframe is temporally arranged with a start of an OFDM symbol nₛ^{μ}N_{symb}^{slot} in the same subframe. All terminals may not perform transmission and reception at the same time, which means that all OFDM symbols of a downlink slot or an uplink slot may not be used. Table 3 represents the number of OFDM symbols per slot (N_{symb}^{slot}), the number of slots per radio frame (Nₛₗₒₜ^{frame,μ}) and the number of slots per subframe (Nₛₗₒₜ^{subframe,μ}) in a normal CP and Table 4 represents the number of OFDM symbols per slot, the number of slots per radio frame and the number of slots per subframe in an extended CP.

TABLE 3

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

TABLE 4

| μ | N_{symb}^{slot} | Nₛₗₒₜ^{frame, μ} | Nₛₗₒₜ^{subframe, μ} |
|---|---|---|---|
| 2 | 12 | 40 | 4 |

FIG. 2 is an example on μ=² (SCS is 60 kHz), 1 subframe may include 4 slots referring to Table 3. 1 subframe={1,2,4} slot shown in FIG. 2 is an example, the number of slots which may be included in 1 subframe is defined as in Table 3 or Table 4. In addition, a mini-slot may include 2, 4 or 7 symbols or more or less symbols. Regarding a physical resource in a NR system, an antenna port, a resource grid, a resource element, a resource block, a carrier part, etc. may be considered. Hereinafter, the physical resources which may be considered in an NR system will be described in detail.

First, in relation to an antenna port, an antenna port is defined so that a channel where a symbol in an antenna port is carried can be inferred from a channel where other symbol in the same antenna port is carried. When a large-scale property of a channel where a symbol in one antenna port is carried may be inferred from a channel where a symbol in other antenna port is carried, it may be said that 2 antenna ports are in a QC/QCL (quasi co-located or quasi co-location) relationship. In this case, the large-scale property includes at least one of delay spread, doppler spread, frequency shift, average received power, received timing.

FIG. 3 illustrates a resource grid in a wireless communication system to which the present disclosure may be applied.

In reference to FIG. 3, it is illustratively described that a resource grid is configured with N_{RB}^{μ}N_{sc}^{RB} subcarriers in a frequency domain and one subframe is configured with 14·2^{μ} OFDM symbols, but it is not limited thereto. In an NR system, a transmitted signal is described by OFDM symbols of 2^{μ}N_{symb}^{(μ)} and one or more resource grids configured with N_{RB}^{μ}N_{sc}^{RB} subcarriers. Here, N_{RB}^{μ}≤N_{RB}^{max,μ}. The N_{RB}^{max,μ} represents a maximum transmission bandwidth, which may be different between an uplink and a downlink as well as between numerologies. In this case, one resource grid may be configured per μ and antenna port p. Each element of a resource grid for μ and an antenna port p is referred to as a resource element and is uniquely identified by an index pair (k,l′). Here, k=0, . . . , N_{RB}^{μ}N_{sc}^{RB}−1 is an index in a frequency domain and l′=0, . . . , 2^{μ}N_{symb}^{(μ)}−1 refers to a position of a symbol in a subframe. When referring to a resource element in a slot, an index pair (k,l) is used. Here, l=0, . . . , N_{symb}^{μ}−1. A resource element (k,l′) for μ and an antenna port p corresponds to a complex value, a_{k,l′}^{(p,μ)}. When there is no risk of confusion or when a specific antenna port or numerology is not specified, indexes p and μ may be dropped, whereupon a complex value may be a_{k,l′}^{(p)} or a_{k,l′}. In addition, a resource block (RB) is defined as N_{sc}^{RB}=12 consecutive subcarriers in a frequency domain.

Point A plays a role as a common reference point of a resource block grid and is obtained as follows.
offsetToPointA for a primary cell (PCell) downlink represents a frequency offset between point A and the lowest subcarrier of the lowest resource block overlapped with a SS/PBCH block which is used by a terminal for an initial cell selection. It is expressed in resource block units assuming a 15 kHz subcarrier spacing for FR1 and a 60 kHz subcarrier spacing for FR2.
absoluteFrequencyPointA represents a frequency-position of point A expressed as in ARFCN (absolute radio-frequency channel number).

Common resource blocks are numbered from 0 to the top in a frequency domain for a subcarrier spacing configuration μ. The center of subcarrier 0 of common resource block 0 for a subcarrier spacing configuration μ is identical to ‘point A’. A relationship between a common resource block number n_{CRB}^{μ} and a resource element (k, l) for a subcarrier spacing configuration p in a frequency domain is given as in the following Equation 1.

$${n}_{CRB}^{μ} = ⌊ \frac{k}{{N}_{s c}^{RB}} ⌋ \qquad [ Equation 1 ]$$

In Equation 1, k is defined relatively to point A so that k=0 corresponds to a subcarrier centering in point A. Physical resource blocks are numbered from 0 to N_{BWP,i}^{size,μ}−1 in a bandwidth part (BWP) and i is a number of a BWP. A relationship between a physical resource block n_{PRB} and a common resource block n_{CRB} in BWP i is given by the following Equation 2.

n_{CRB}^{μ}=n_{PRB}^{μ}+N_{BWP,i}^{start,μ} [Equation 2]

N_{BWP,i}^{start,μ} is a common resource block that a BWP starts relatively to common resource block 0.

FIG. 4 illustrates a physical resource block in a wireless communication system to which the present disclosure may be applied. And, FIG. 5 illustrates a slot structure in a wireless communication system to which the present disclosure may be applied.

In reference to FIG. 4 and FIG. 5, a slot includes a plurality of symbols in a time domain. For example, for a normal CP, one slot includes 7 symbols, but for an extended CP, one slot includes 6 symbols.

A carrier includes a plurality of subcarriers in a frequency domain. An RB (Resource Block) is defined as a plurality of (e.g., 12) consecutive subcarriers in a frequency domain. A BWP (Bandwidth Part) is defined as a plurality of consecutive (physical) resource blocks in a frequency domain and may correspond to one numerology (e.g., an SCS, a CP length, etc.). A carrier may include a maximum N (e.g., 5) BWPs. A data communication may be performed through an activated BWP and only one BWP may be activated for one terminal. In a resource grid, each element is referred to as a resource element (RE) and one complex symbol may be mapped.

In an NR system, up to 400 MHz may be supported per component carrier (CC). If a terminal operating in such a wideband CC always operates turning on a radio frequency (FR) chip for the whole CC, terminal battery consumption may increase. Alternatively, when several application cases operating in one wideband CC (e.g., eMBB, URLLC, Mmtc, V2X, etc.) are considered, a different numerology (e.g., a subcarrier spacing, etc.) may be supported per frequency band in a corresponding CC. Alternatively, each terminal may have a different capability for the maximum bandwidth. By considering it, a base station may indicate a terminal to operate only in a partial bandwidth, not in a full bandwidth of a wideband CC, and a corresponding partial bandwidth is defined as a bandwidth part (BWP) for convenience. A BWP may be configured with consecutive RBs on a frequency axis and may correspond to one numerology (e.g., a subcarrier spacing, a CP length, a slot/a mini-slot duration).

Meanwhile, a base station may configure a plurality of BWPs even in one CC configured to a terminal. For example, a BWP occupying a relatively small frequency domain may be configured in a PDCCH monitoring slot, and a PDSCH indicated by a PDCCH may be scheduled in a greater BWP. Alternatively, when UEs are congested in a specific BWP, some terminals may be configured with other BWP for load balancing. Alternatively, considering frequency domain inter-cell interference cancellation between neighboring cells, etc., some middle spectrums of a full bandwidth may be excluded and BWPs on both edges may be configured in the same slot. In other words, a base station may configure at least one DL/UL BWP to a terminal associated with a wideband CC. A base station may activate at least one DL/UL BWP of configured DL/UL BWP(s) at a specific time (by L1 signaling or MAC CE (Control Element) or RRC signaling, etc.). In addition, a base station may indicate switching to other configured DL/UL BWP (by L1 signaling or MAC CE or RRC signaling, etc.). Alternatively, based on a timer, when a timer value is expired, it may be switched to a determined DL/UL BWP. Here, an activated DL/UL BWP is defined as an active DL/UL BWP. But, a configuration on a DL/UL BWP may not be received when a terminal performs an initial access procedure or before a RRC connection is set up, so a DL/UL BWP which is assumed by a terminal under these situations is defined as an initial active DL/UL BWP.

FIG. 6 illustrates physical channels used in a wireless communication system to which the present disclosure may be applied and a general signal transmission and reception method using them.

In a wireless communication system, a terminal receives information through a downlink from a base station and transmits information through an uplink to a base station. Information transmitted and received by a base station and a terminal includes data and a variety of control information and a variety of physical channels exist according to a type/a usage of information transmitted and received by them.

When a terminal is turned on or newly enters a cell, it performs an initial cell search including synchronization with a base station or the like (S601). For the initial cell search, a terminal may synchronize with a base station by receiving a primary synchronization signal (PSS) and a secondary synchronization signal (SSS) from a base station and obtain information such as a cell identifier (ID), etc. After that, a terminal may obtain broadcasting information in a cell by receiving a physical broadcast channel (PBCH) from a base station. Meanwhile, a terminal may check out a downlink channel state by receiving a downlink reference signal (DL RS) at an initial cell search stage.

A terminal which completed an initial cell search may obtain more detailed system information by receiving a physical downlink control channel (PDCCH) and a physical downlink shared channel (PDSCH) according to information carried in the PDCCH (S602).

Meanwhile, when a terminal accesses to a base station for the first time or does not have a radio resource for signal transmission, it may perform a random access (RACH) procedure to a base station (S603 to S606). For the random access procedure, a terminal may transmit a specific sequence as a preamble through a physical random access channel (PRACH) (S603 and S605) and may receive a response message for a preamble through a PDCCH and a corresponding PDSCH (S604 and S606). A contention based RACH may additionally perform a contention resolution procedure.

A terminal which performed the above-described procedure subsequently may perform PDCCH/PDSCH reception (S607) and PUSCH (Physical Uplink Shared Channel)/PUCCH (physical uplink control channel) transmission (S608) as a general uplink/downlink signal transmission procedure. In particular, a terminal receives downlink control information (DCI) through a PDCCH. Here, DCI includes control information such as resource allocation information for a terminal and a format varies depending on its purpose of use.

Meanwhile, control information which is transmitted by a terminal to a base station through an uplink or is received by a terminal from a base station includes a downlink/uplink ACK/NACK (Acknowledgement/Non-Acknowledgement) signal, a CQI (Channel Quality Indicator), a PMI (Precoding Matrix Indicator), a RI (Rank Indicator), etc. For a 3GPP LTE system, a terminal may transmit control information of the above-described CQI/PMI/RI, etc. through a PUSCH and/or a PUCCH.

Table 5 represents an example of a DCI format in an NR system.

TABLE 5

| DCI Format | Use |
|---|---|
| 0_0 | Scheduling of a PUSCH in one cell |
| 0_1 | Scheduling of one or multiple PUSCHs in one cell, or |
| | indication of cell group downlink feedback information |
| | to a UE |
| 0_2 | Scheduling of a PUSCH in one cell |
| 1_0 | Scheduling of a PDSCH in one DL cell |
| 1_1 | Scheduling of a PDSCH in one cell |
| 1_2 | Scheduling of a PDSCH in one cell |

In reference to Table 5, DCI formats 0_0, 0_1 and 0_2 may include resource information (e.g., UL/SUL (Supplementary UL), frequency resource allocation, time resource allocation, frequency hopping, etc.), information related to a transport block (TB) (e.g., MCS (Modulation Coding and Scheme), a NDI (New Data Indicator), a RV (Redundancy Version), etc.), information related to a HARQ (Hybrid —Automatic Repeat and request) (e.g., a process number, a DAI (Downlink Assignment Index), PDSCH-HARQ feedback timing, etc.), information related to multiple antennas (e.g., DMRS sequence initialization information, an antenna port, a CSI request, etc.), power control information (e.g., PUSCH power control, etc.) related to scheduling of a PUSCH and control information included in each DCI format may be pre-defined. DCI format 0_0 is used for scheduling of a PUSCH in one cell. Information included in DCI format 0_0 is CRC (cyclic redundancy check) scrambled by a C-RNTI (Cell Radio Network Temporary Identifier) or a CS-RNTI (Configured Scheduling RNTI) or a MCS-C-RNTI (Modulation Coding Scheme Cell RNTI) and transmitted.

DCI format 0_1 is used to indicate scheduling of one or more PUSCHs or configure grant (CG) downlink feedback information to a terminal in one cell. Information included in DCI format 0_1 is CRC scrambled by a C-RNTI or a CS-RNTI or a SP-CSI-RNTI (Semi-Persistent CSI RNTI) or a MCS-C-RNTI and transmitted.

DCI format 0_2 is used for scheduling of a PUSCH in one cell. Information included in DCI format 0_2 is CRC scrambled by a C-RNTI or a CS-RNTI or a SP-CSI-RNTI or a MCS-C-RNTI and transmitted.

Next, DCI formats 1_0, 1_1 and 1_2 may include resource information (e.g., frequency resource allocation, time resource allocation, VRB (virtual resource block)-PRB (physical resource block) mapping, etc.), information related to a transport block (TB) (e.g., MCS, NDI, RV, etc.), information related to a HARQ (e.g., a process number, DAI, PDSCH-HARQ feedback timing, etc.), information related to multiple antennas (e.g., an antenna port, a TCI (transmission configuration indicator), a SRS (sounding reference signal) request, etc.), information related to a PUCCH (e.g., PUCCH power control, a PUCCH resource indicator, etc.) related to scheduling of a PDSCH and control information included in each DCI format may be pre-defined.

DCI format 1_0 is used for scheduling of a PDSCH in one DL cell. Information included in DCI format 1_0 is CRC scrambled by a C-RNTI or a CS-RNTI or a MCS-C-RNTI and transmitted.

DCI format 1_1 is used for scheduling of a PDSCH in one cell. Information included in DCI format 1_1 is CRC scrambled by a C-RNTI or a CS-RNTI or a MCS-C-RNTI and transmitted.

DCI format 1_2 is used for scheduling of a PDSCH in one cell. Information included in DCI format 1_2 is CRC scrambled by a C-RNTI or a CS-RNTI or a MCS-C-RNTI and transmitted.

Beam Management (BM)

A BM procedure is L1 (layer 1)/L2 (layer 2) procedures to obtain and maintain a set of beams of a base station (e.g., a gNB, a TRP, etc.) and/or terminal (e.g., a UE) beams which may be used for downlink (DL) and uplink (UL) transmission/reception, it may include the following procedures and terms.

Beam measurement: An operation that a base station or a UE measures a property of a received beamformed signal

Beam determination: An operation that a base station or a UE selects its Tx beam/Rx beam

Beam sweeping: An operation that a spatial region is covered by using a Tx and/or Rx beam for a certain time interval in a pre-determined method

Beam report: An operation that a UE reports information of a beamformed signal based on beam measurement

A BM procedure may be classified into (1) a DL BM procedure using a SS (synchronization signal)/PBCH (physical broadcast channel) Block or a CSI-RS and (2) an UL BM procedure using an SRS (sounding reference signal).

In addition, each BM procedure may include Tx beam sweeping for determining a Tx Beam and Rx beam sweeping for determining a Rx beam.

Hereinafter, a DL BM procedure will be described.

A DL BM procedure may include (1) transmission of beamformed DL RSs (reference signals) of a base station (e.g., a CSI-RS or a SS Block (SSB)) and (2) beam reporting of a terminal.

Here, beam reporting may include preferred DL RS ID (identifier) (s) and corresponding L1-RSRP (Reference Signal Received Power).

The DL RS ID may be a SSBRI (SSB Resource Indicator) or a CRI (CSI-RS Resource Indicator).

Hereinafter, a DL BM procedure using an SSB will be described.

FIG. 7 is a diagram which illustrates a downlink beam management operation in a wireless communication system to which the present disclosure may be applied.

In reference to FIG. 7, an SSB beam and a CSI-RS beam may be used for beam measurement. A measurement metric is L1-RSRP per resource/block. An SSB may be used for coarse beam measurement and a CSI-RS may be used for fine beam measurement. An SSB may be used for both of Tx beam sweeping and Rx beam sweeping.

Rx beam sweeping using an SSB may be performed while an UE changes an Rx beam for the same SSBRI across a plurality of SSB bursts. In this case, one SS burst includes one or more SSBs and one SS burst set includes one or more SSB bursts.

FIG. 8 is a diagram which illustrates a downlink beam management procedure using SSB in a wireless communication system to which the present disclosure may be applied.

A configuration on a beam report using an SSB is performed in a CSI/beam configuration in a RRC connected state (or a RRC connected mode).

In reference to FIG. 8, a terminal receives CSI-ResourceConfig IE including CSI-SSB-ResourceSetList including SSB resources used for BM from a base station (410)

Table 6 represents an example of CSI-ResourceConfig IE and as in Table 6, a BM configuration using an SSB configures an SSB like a CSI-RS resource without being separately defined.

TABLE 6

| | |
|---|---|
| -- ASN1START | |
| -- TAG-CSI-RESOURCECONFIG-START | |
| CSI-ResourceConfig ::= | SEQUENCE { |
| csi-ResourceConfigId | CSI-ResourceConfigId, |
| csi-RS-ResourceSetList | CHOICE { |
| nzp-CSI-RS-SSB | SEQUENCE { |

nzp-CSI-RS-ResourceSetList SEQUENCE (SIZE
(1..maxNrofNZP-CSI-RS-ResourceSetsPerConfig)) OF NZP-CSI-RS-ResourceSetId

OPTIONAL,

csi-SSB-ResourceSetList SEQUENCE (SIZE
(1..maxNrofCSI-SSB-ResourceSetsPerConfig)) OF CSI-SSB-ResourceSetId

| | |
|---|---|
| OPTIONAL | |
| }, | |
| csi-IM-ResourceSetList | SEQUENCE (SIZE (1..maxNrofCSI-IM- |

ResourceSetsPerConfig)) OF CSI-IM-ResourceSetId

| | |
|---|---|
| }, | |
| bwp-Id | BWP-Id, |

resourceType ENUMERATED { aperiodic, semiPersistent,

periodic },
...
}

-- TAG-CSI-RESOURCECONFIGTOADDMOD-STOP
-- ASN1STOP

In Table 6, a csi-SSB-ResourceSetList parameter represents a list of SSB resources used for beam management and reporting in one resource set. Here, an SSB resource set may be configured as {SSBx1, SSBx2, SSBx3, SSBx4, . . . }. An SSB index may be defined from 0 to 63. A terminal receives an SSB resource from the base station based on the CSI-SSB-ResourceSetList (S420).

When CSI-RS reportConfig related to a report on a SSBRI and L1-RSRP is configured, the terminal performs (beam) reporting of the best SSBRI and corresponding L1-RSRP to a base station (S430).

Hereinafter, a DL BM procedure using a CSI-RS will be described.

Describing a usage of a CSI-RS, i) a repetition parameter is configured for a specific CSI-RS resource set and when TRS_info is not configured, a CSI-RS is used for beam management. ii) when a repetition parameter is not configured and TRS_info is configured, a CSI-RS is used for a TRS (tracking reference signal). iii) when a repetition parameter is not configured and TRS_info is not configured, a CSI-RS is used for CSI acquisition.

Such a repetition parameter may be configured only for CSI-RS resource sets associated with CSI-ReportConfig having a report of L1 RSRP or ‘No Report (or None)’.

If a terminal is configured with CSI-ReportConfig in which reportQuantity is configured as ‘cri-RSRP’ or ‘none’ and CSI-ResourceConfig for channel measurement (a higher layer parameter resourcesForChannelMeasurement) does not include a higher layer parameter ‘trs-Info’ and includes NZP-CSI-RS-ResourceSet in which a higher layer parameter ‘repetition’ is configured, the terminal may be configured only with a same number of port (1-port or 2-port) having a higher layer parameter ‘nrofPorts’ for all CSI-RS resources in NZP-CSI-RS-ResourceSet.

When (a higher layer parameter) repetition is configured as ‘ON’, it is related to a Rx beam sweeping procedure of a terminal. In this case, when a terminal is configured with NZP-CSI-RS-ResourceSet, the terminal may assume that at least one CSI-RS resource in NZP-CSI-RS-ResourceSet is transmitted with the same downlink spatial domain transmission filter. In other words, at least one CSI-RS resource in NZP-CSI-RS-ResourceSet is transmitted through the same Tx beam. Here, at least one CSI-RS resource in NZP-CSI-RS-ResourceSet may be transmitted in a different OFDM symbol. In addition, a terminal does not expect to receive a different periodicity in periodicityAndOffset in all CSI-RS resources in NZP-CSI-RS-Resourceset.

Meanwhile, when repetition is configured as ‘OFF’, it is related to a Tx beam sweeping procedure of a base station. In this case, when repetition is configured as ‘OFF’, a terminal does not assume that at least one CSI-RS resource in NZP-CSI-RS-ResourceSet is transmitted in the same downlink spatial domain transmission filter. In other words, at least one CSI-RS resource in NZP-CSI-RS-ResourceSet is transmitted through a different Tx beam.

In other words, when reportQuantity of the CSI-RS reportConfig IE is configured as ‘ssb-Index-RSRP’, a terminal reports the best SSBRI and corresponding L1-RSRP to a base station.

In addition, when a CSI-RS resource may be configured in the same OFDM symbol(s) as an SSB (SS/PBCH Block) and ‘QCL-TypeD’ is applicable, the terminal may assume that a CSI-RS and an SSB are quasi co-located with regard to ‘QCL-TypeD’.

Here, the QCL TypeD may mean that antenna ports are quasi-colocated with regard to a spatial Rx parameter. When a terminal receives a plurality of DL antenna ports in a QCL Type D relationship, it is allowed to apply the same Rx beam. In addition, a terminal does not expect that a CSI-RS will be configured in a RE overlapped with a RE of an SSB.

FIG. 9 is a diagram which illustrates a downlink beam management operation using CSI-RS in a wireless communication system to which the present disclosure may be applied.

FIG. 9(a) represents a Rx beam determination (or refinement) procedure of a terminal and FIG. 9(b) represents a Tx beam sweeping procedure of a base station. In addition, FIG. 9(a) is a case when a repetition parameter is configured as ‘ON’ and FIG. 9(b) is a case when a repetition parameter is configured as ‘OFF’.

FIG. 10 is a diagram which illustrates an Rx beam determination process of a terminal in a wireless communication system to which the present disclosure may be applied.

In reference to FIG. 9(a) and FIG. 10, an Rx beam determination process of a terminal is described.

A terminal receives NZP CSI-RS resource set IE including a higher layer parameter repetition through RRC signaling from a base station (S610). Here, the repetition parameter is configured as ‘ON’.

A terminal repetitively receives resources in a CSI-RS resource set configured as repetition ‘ON’ through the same Tx beam (or DL spatial domain transmission filter) of a base station in a different OFDM symbol (S620).

A terminal determines its Rx beam (S630).

A terminal omits a CSI report (S640). In this case, reportQuantity of a CSI report configuration may be configured as ‘No report (or None)’.

In other words, the terminal may omit a CSI report when it is configured as repetition ‘ON’.

FIG. 11 is a diagram which illustrates a Tx beam determination process of a base station in a wireless communication system to which the present disclosure may be applied.

In reference to FIG. 9(b) and FIG. 11, a Tx beam determination process of a base station is described.

A terminal receives NZP CSI-RS resource set IE including a higher layer parameter repetition through RRC signaling from a base station (S710). Here, the repetition parameter is configured as ‘OFF’ and it is related to a Tx beam sweeping procedure of a base station.

A terminal receives resources in a CSI-RS resource set configured as repetition ‘OFF’ through a different Tx beam (or DL spatial domain transmission filter) of a base station (S720).

A terminal selects (or determines) the best beam (S740).

A terminal reports an ID and related quality information (e.g., L1-RSRP) of a selected beam to a base station (S740). In this case, reportQuantity of a CSI report configuration may be configured as ‘CRI+L1-RSRP’.

In other words, when a CSI-RS is transmitted for BM, the terminal reports a CRI and a related L1-RSRP.

FIG. 12 is a diagram which illustrates resource allocation in a time and frequency domain related to a downlink beam management operation in a wireless communication system to which the present disclosure may be applied.

In reference to FIG. 12, it is shown that when repetition ‘ON’ is configured in a CSI-RS resource set, a plurality of CSI-RS resources are repetitively used by applying the same Tx beam and when repetition ‘OFF’ is configured in a CSI-RS resource set, different CSI-RS resources are transmitted in a different Tx beam.

Hereinafter, a beam indication method related to downlink BM will be described.

A terminal may be configured by RRC with a list of a maximum M candidate transmission configuration indication (TCI) states at least for a purpose of a QCL (Quasi Co-location) indication. Here, M may be 64.

Each TCI state may be configured as one RS set. Each ID of a DL RS at least for a spatial QCL purpose (QCL Type D) in a RS set may refer to one of DL RS types such as an SSB, a P (periodic)-CSI RS, an SP (semi-persistent)-CSI RS, an A (aperiodic)-CSI RS, etc.

An ID of DL RS(s) in a RS set used at least for a purpose of a spatial QCL may be initialized/updated at least by explicit signaling.

Table 7 illustrates a TCI-State information element (IE).

A TCI-State IE is associated with a quasi co-location (QCL) type corresponding to one or two DL reference signals (RS).

TABLE 7

| | |
|---|---|
| -- ASN1START | |
| -- TAG-TCI-STATE-START | |
| TCI-State ::= | SEQUENCE { |
| tci-StateId | TCI-StateId, |
| qcl-Type1 | QCL-Info, |
| qcl-Type2 | QCL-Info |

```
                        OPTIONAL, -- Need R
    ...
```

| | |
|---|---|
| } | |
| QCL-Info ::= | SEQUENCE { |
| cell | ServCellIndex |
| | OPTIONAL, -- Need R |
| bwp-Id | BWP-Id |

OPTIONAL, -- Cond CSI-RS-Indicated

| | |
|---|---|
| referenceSignal | CHOICE { |
| csi-rs | NZP-CSI-RS-ResourceId, |
| ssb | SSB-Index |
| }, | |
| qcl-Type | ENUMERATED {typeA, typeB, typeC, typeD}, |
| ... | |
| } | |
| -- TAG-TCI-STATE-STOP | |
| -- ASN1STOP | |

In Table 7, a bwp-Id parameter represents a DL BWP (bandwidth part) where an RS is located, a cell parameter represents a carrier where a RS is located and a reference signal parameter represents reference antenna port(s) which is a source of a quasi co-location for corresponding target antenna port(s) or a reference signal including it. The target antenna port(s) may be a CSI-RS, a PDCCH DMRS, or a PDSCH DMRS. In an example, a corresponding TCI state ID (identifier) may be indicated in NZP CSI-RS resource configuration information to indicate QCL reference RS information for a NZP (non-zero power) CSI-RS. In another example, a TCI state ID may be indicated to each CORESET configuration to indicate QCL reference information for PDCCH DMRS antenna port(s). In another example, a TCI state ID may be indicated through DCI to indicate QCL reference information for PDSCH DMRS antenna port(s).

Hereinafter, uplink beam management will be described.

For UL BM, beam reciprocity (or beam correspondence) between a Tx beam and a Rx beam may be valid or may not be valid according to terminal implementation. If reciprocity between a Tx beam and a Rx beam is valid both in a base station and a terminal, a UL beam pair may be matched by a DL beam pair. But, when reciprocity between a Tx beam and a Rx beam is not valid in any one of a base station and a terminal, a process for determining a UL beam pair is required separately from a DL beam pair determination.

In addition, although both of a base station and a terminal maintain beam correspondence, a base station may use a UL BM procedure for determining a DL Tx beam without requesting a terminal to report a preferred beam.

UL BM may be performed through beamformed UL SRS transmission and whether UL BM of an SRS resource set is applied may be configured by a (higher layer parameter) usage. When a usage is configured as ‘BeamManagement (BM)’, only one SRS resource may be transmitted in each of a plurality of SRS resource sets in a given time instant.

A terminal may be configured with one or more SRS(Sounding Reference Symbol) resource sets configured by (a higher layer parameter) SRS-ResourceSet (through higher layer signaling, RRC signaling, etc.) For each SRS resource set, a UE may be configured with K≥1 SRS resources (a higher layer parameter SRS-resource). Here, K is a natural number and the maximum number of K is indicated by SRS_capability.

Like DL BM, an UL BM procedure may be also classified into Tx beam sweeping of a terminal and Rx beam sweeping of a base station.

FIG. 13 is a diagram which illustrates an uplink beam management operation using SRS in a wireless communication system to which the present disclosure may be applied.

FIG. 13(a) illustrates a Rx beam determination operation of a base station and FIG. 13(b) illustrates a Tx beam sweeping operation of a terminal.

FIG. 14 is a diagram which illustrates an uplink beam management procedure in a wireless communication system to which the present disclosure may be applied.

A terminal receives RRC signaling (e.g., an SRS-Config IE) including a (higher layer parameter) usage parameter configured as ‘beam management’ from a base station (S1010).

Table 8 represents an example of an SRS-Config IE (Information Element) and an SRS-Config IE is used for SRS transmission configuration. An SRS-Config IE includes a list of SRS-Resources and a list of SRS-ResourceSets. Each SRS resource set means a set of SRS-resources.

A network may trigger transmission of an SRS resource set by using configured aperiodicSRS-ResourceTrigger (L1 DCI).

TABLE 8

| | |
|---|---|
| -- ASN1START | |
| -- TAG-MAC-CELL-GROUP-CONFIG-START | |
| SRS-Config ::= | SEQUENCE { |
| srs-ResourceSetToReleaseList | SEQUENCE (SIZE(1..maxNrofSRS- |
| ResourceSets)) OF SRS-ResourceSetId | OPTIONAL, -- Need N |
| srs-Re sourceSetToAddModList | SEQUENCE (SIZE(1..maxNrofSRS- |
| ResourceSets)) OF SRS-ResourceSet | OPTIONAL, -- Need N |
| srs-ResourceToReleaseList | SEQUENCE (SIZE (1..maxNrofSRS- |
| Resources)) OF SRS-ResourceId | OPTIONAL, -- Need N |
| srs-ResourceToAddModList | SEQUENCE (SIZE(1..maxNrofSRS- |
| Resources)) OF SRS-Resource | OPTIONAL, -- Need N |
| tpc-Accumulation | ENUMERATED {disabled} |
| | OPTIONAL, -- Need S |
| ... | |
| } | |
| SRS-ResourceSet ::= | SEQUENCE { |
| srs-ResourceSetId | SRS-ResourceSetId, |
| srs-ResourceIdList | SEQUENCE (SIZE(1..maxNrofSRS- |
| ResourcesPerSet)) OF SRS-ResourceId | OPTIONAL, -- Cond Setup |
| resourceType | CHOICE { |
| aperiodic | SEQUENCE { |

aperiodicSRS-ResourceTrigger INTEGER (1..maxNrofSRS-

| | |
|---|---|
| TriggerStates-1), | |
| csi-RS | NZP-CSI-RS-ResourceId |

OPTIONAL,-- Cond NonCodebook

| | |
|---|---|
| slotOffset | INTEGER (1..32) |
| | OPTIONAL, -- Need S |
| ... | |
| }, | |
| semi-persistent | SEQUENCE { |
| associatedCSI-RS | NZP-CSI-RS-ResourceId |
| | OPTIONAL, -- Cond NonCodebook |
| ... | |
| }, | |
| periodic | SEQUENCE { |
| associatedCSI-RS | NZP-CSI-RS-ResourceId |
| | OPTIONAL, -- Cond NonCodebook |
| ... | |
| } | |
| }, | |

usage ENUMERATED {beamManagement,
codebook, nonCodebook, antennaSwitching},

| | |
|---|---|
| alpha | Alpha |

OPTIONAL, -- Need S

| | |
|---|---|
| p0 | INTEGER (−202..24) |

OPTIONAL, -- Cond Setup

| | |
|---|---|
| pathlossReferenceRS | CHOICE { |
| ssb-Index | SSB-Index, |
| csi-RS-Index | NZP-CSI-RS-ResourceId |

SRS-SpatialRelationInfo ::= SEQUENCE {

| | |
|---|---|
| servingCellId | ServCellIndex |
| OPTIONAL, -- Need S | |

referenceSignal CHOICE {

| | |
|---|---|
| ssb-Index | SSB-Index, |
| csi-RS-Index | NZP-CSI-RS-ResourceId, |
| srs | SEQUENCE { |
| resourceId | SRS-ResourceId, |
| uplinkBWP | BWP-Id |
| } | |
| } | |
| } | |
| SRS-ResourceId ::= | INTEGER (0..maxNrofSRS-Resources-1) |

In Table 8, usage represents a higher layer parameter which indicates whether an SRS resource set is used for beam management or is used for codebook-based or non-codebook-based transmission. A usage parameter corresponds to a L1 parameter ‘SRS-SetUse’. ‘spatialRelationInfo’ is a parameter which represents a configuration of a spatial relation between a reference RS and a target SRS. Here, a reference RS may be a SSB, a CSI-RS or a SRS corresponding to a L1 parameter ‘SRS-SpatialRelationInfo’. The usage is configured per SRS resource set. A terminal determines a Tx beam for an SRS resource which will be transmitted based on SRS-SpatialRelation Info included in the SRS-Config IE (S1020). Here, SRS-SpatialRelation Info is configured per SRS resource and represents whether the same beam as a beam used in a SSB, a CSI-RS or a SRS will be applied per SRS resource. In addition, SRS-SpatialRelationInfo may be configured or may not be configured for each SRS resource.

If SRS-SpatialRelationInfo is configured for an SRS resource, the same beam as a beam used in a SSB, a CSI-RS or a SRS is applied and transmitted. But, if SRS-SpatialRelationInfo is not configured for an SRS resource, the terminal randomly determines a Tx beam and transmits an SRS through the determined Tx beam (S1030).

In more detail, for a P-SRS that ‘SRS-ResourceConfigType’ is configured as ‘periodic’:

i) when SRS-SpatialRelationInfo is configured as ‘SSB/PBCH’, a UE transmits a corresponding SRS resource by applying the same spatial domain transmission filter (or generated by a corresponding filter) as a spatial domain Rx filter used for SSB/PBCH reception; or

ii) when SRS-SpatialRelationInfo is configured as ‘CSI-RS’, a UE transmits a SRS resource by applying the same spatial domain transmission filter used for periodic CSI-RS or SP (semi-persistent) CSI-RS reception; or

iii) when SRS-SpatialRelationInfo is configured as ‘SRS’, a UE transmits a corresponding SRS resource by applying the same spatial domain transmission filter used for periodic SRS transmission.

Although ‘SRS-ResourceConfigType’ is configured as ‘SP (semi-persistent)-SRS’ or ‘AP (aperiodic)-SRS’, a beam determination and transmission operation may be applied in a way similar to the above.

Additionally, a terminal may receive or may not receive a feedback on an SRS from a base station as in the following three cases (S1040).

i) when Spatial_Relation_Info is configured for all SRS resources in a SRS resource set, a terminal transmits an SRS with a beam indicated by a base station. For example, when Spatial_Relation_Info indicates all the same SSB, CRI or SRI, a terminal repetitively transmits an SRS with the same beam. This case corresponds to FIG. 13(a) as a usage for a base station to select an Rx beam.

ii) Spatial_Relation_Info may not be configured for all SRS resources in an SRS resource set. In this case, a terminal may transmit with freely changing SRS beams. In other words, this case corresponds to FIG. 13(b) as a usage for a terminal to sweep Tx beams.

iii) Spatial_Relation_Info may be configured only for a part of SRS resources in an SRS resource set. In this case, for a configured SRS resource, an SRS may be transmitted with an indicated beam, and for a SRS resource that Spatial_Relation_Info is not configured an SRS may be transmitted by randomly applying a Tx beam by a terminal.

Quasi-Co Location (QCL)

An antenna port is defined so that a channel where a symbol in an antenna port is transmitted can be inferred from a channel where other symbol in the same antenna port is transmitted. When a property of a channel where a symbol in one antenna port is carried may be inferred from a channel where a symbol in other antenna port is carried, it may be said that 2 antenna ports are in a QC/QCL (quasi co-located or quasi co-location) relationship.

Here, the channel property includes at least one of delay spread, doppler spread, frequency/doppler shift, average received power, received timing/average delay, or a spatial RX parameter. Here, a spatial Rx parameter means a spatial (Rx) channel property parameter such as an angle of arrival.

A terminal may be configured at list of up to M TCI-State configurations in a higher layer parameter PDSCH-Config to decode a PDSCH according to a detected PDCCH having intended DCI for a corresponding terminal and a given serving cell. The M depends on UE capability.

Each TCI-State includes a parameter for configuring a quasi co-location relationship between ports of one or two DL reference signals and a DM-RS (demodulation reference signal) of a PDSCH.

A quasi co-location relationship is configured by a higher layer parameter qcl-Type1 for a first DL RS and qcl-Type2 for a second DL RS (if configured). For two DL RSs, a QCL type is not the same regardless of whether a reference is a same DL RS or a different DL RS.

A QCL type corresponding to each DL RS is given by a higher layer parameter qcl-Type of QCL-Info and may take one of the following values.
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}

For example, when a target antenna port is a specific NZP CSI-RS, it may be indicated/configured that a corresponding NZP CSI-RS antenna port is quasi-colocated with a specific TRS with regard to QCL-Type A and is quasi-colocated with a specific SSB with regard to QCL-Type D. A terminal received such indication/configuration may receive a corresponding NZP CSI-RS by using a doppler, delay value measured in a QCL-TypeA TRS and apply a Rx beam used for receiving QCL-TypeD SSB to reception of a corresponding NZP CSI-RS.

UE may receive an activation command by MAC CE signaling used to map up to 8 TCI states to a codepoint of a DCI field ‘Transmission Configuration Indication’.

When HARQ-ACK corresponding to a PDSCH carrying an activation command is transmitted in a slot n, mapping indicated between a TCI state and a codepoint of a DCI field ‘Transmission Configuration Indication’ may be applied by starting from a slot n+3Nₛₗₒₜ^{subframe,μ}+1. After UE receives an initial higher layer configuration for TCI states before receiving an activation command, UE may assume for QCL-TypeA, and if applicable, for QCL-TypeD that a DMRS port of a PDSCH of a serving cell is quasi-colocated with a SS/PBCH block determined in an initial access process.

When a higher layer parameter (e.g., tci-PresentInDCI) indicating whether there is a TCI field in DCI configured for UE is set to be enabled for a CORESET scheduling a PDSCH, UE may assume that there is a TCI field in DCI format 1_1 of a PDCCH transmitted in a corresponding CORESET. When tci-PresentInDCI is not configured for a CORESET scheduling a PDSCH or when a PDSCH is scheduled by DCI format 1_0 and a time offset between reception of DL DCI and a corresponding PDSCH is equal to or greater than a predetermined threshold (e.g., timeDurationForQCL), in order to determine a PDSCH antenna port QCL, UE may assume that a TCI state or a QCL assumption for a PDSCH is the same as a TCI state or a QCL assumption applied to a CORESET used for PDCCH transmission. Here, the predetermined threshold may be based on reported UE capability.

When a parameter tci-PresentInDCI is set to be enabled, a TCI field in DCI in a scheduling CC (component carrier) may indicate an activated TCI state of a scheduled CC or a DL BWP. When a PDSCH is scheduled by DCI format 11, UE may use a TCI-state according to a value of a ‘Transmission Configuration Indication’ field of a detected PDCCH having DCI to determine a PDSCH antenna port QCL.

When a time offset between reception of DL DCI and a corresponding PDSCH is equal to or greater than a predetermined threshold (e.g., timeDurationForQCL), UE may assume that a DMRS port of a PDSCH of a serving cell is quasi-colocated with RS(s) in a TCI state for QCL type parameter(s) given by an indicated TCI state.

When a single slot PDSCH is configured for UE, an indicated TCI state may be based on an activated TCI state of a slot having a scheduled PDSCH.

When multiple-slot PDSCHs are configured for UE, an indicated TCI state may be based on an activated TCI state of a first slot having a scheduled PDSCH and UE may expect that activated TCI states across slots having a scheduled PDSCH are the same.

When a CORESET associated with a search space set for cross-carrier scheduling is configured for UE, UE may expect that a tci-PresentInDCI parameter is set to be enabled for a corresponding CORESET. When one or more TCI states are configured for a serving cell scheduled by a search space set including QCL-TypeD, UE may expect that a time offset between reception of a PDCCH detected in the search space set and a corresponding PDSCH is equal to or greater than a predetermined threshold (e.g., timeDurationForQCL).

For both of a case in which a parameter tci-PresentInDCI is set to be enabled and a case in which tci-PresentInDCI is not configured in a RRC connected mode, when a time offset between reception of DL DCI and a corresponding PDSCH is less than a predetermined threshold (e.g., timeDurationForQCL), UE may assume that a DMRS port of a PDSCH of a serving cell is quasi-colocated with RS(s) for QCL parameter(s) used for PDCCH QCL indication of a CORESET associated with a monitored search space having the lowest CORESET-ID in the latest slot where one or more CORESETs in an activated BWP of a serving cell is monitored by UE.

In this case, when QCL-TypeD of a PDSCH DMRS is different from QCL-TypeD of a PDCCH DMRS and they are overlapped in at least one symbol, UE may expect that reception of a PDCCH associated with a corresponding CORESET will be prioritized. It may be also applied to intra-band CA (carrier aggregation) (when a PDSCH and a CORESET exist in a different CC). When any of configured TCI states does not include QCL-TypeD, a different QCL assumption may be obtained from TCI states indicated for a scheduled PDSCH, regardless of a time offset between reception of DL DCI and a corresponding PDSCH.

For a periodic CSI-RS resource of configured NZP-CSI-RS-ResourceSet including a higher layer parameter trs-Info, UE may expect a TCI state to indicate one of the following QCL type(s).
QCL-TypeC with a SS/PBCH block, and if applicable, QCL-TypeD with the same SS/PBCH block, or
QCL-TypeC with a SS/PBCH block, and if applicable, QCL-TypeD with a CSI-RS resource in configured NZP-CSI-RS-ResourceSet including a higher layer parameter repetition

For an aperiodic CSI-RS resource of configured NZP-CSI-RS-ResourceSet including a higher layer parameter trs-Info, UE may expect a TCI state to indicate QCL-TypeA with a periodic CSI-RS resource of NZP-CSI-RS-ResourceSet including a higher layer parameter trs-Info, and if applicable, QCL-TypeD with the same periodic CSI-RS resource.

For a CSI-RS resource of NZP-CSI-RS-ResourceSet configured without a higher layer parameter trs-Info and without a higher layer parameter repetition, UE may expect a TCI state to indicate one of the following QCL type(s).
QCL-TypeA with a CSI-RS resource of configured NZP-CSI-RS-ResourceSet including a higher layer parameter trs-Info, and if applicable, QCL-TypeD with the same CSI-RS resource, or
QCL-TypeA with a CSI-RS resource of configured NZP-CSI-RS-ResourceSet including a higher layer parameter trs-Info, and if applicable, QCL-TypeD with a SS/PBCH block, or

QCL-TypeA with a CSI-RS resource of configured NZP-CSI-RS-ResourceSet including a higher layer parameter trs-Info, and if applicable, QCL-TypeD with a CSI-RS resource in configured NZP-CSI-RS-ResourceSet including a higher layer parameter repetition, or

when QCL-TypeD is not applicable, QCL-TypeB with a CSI-RS resource in configured NZP-CSI-RS-ResourceSet including a higher layer parameter trs-Info.

For a CSI-RS resource of configured NZP-CSI-RS-ResourceSet including a higher layer parameter repetition, UE may expect a TCI state to indicate one of the following QCL type (s).
QCL-TypeA with a CSI-RS resource of configured NZP-CSI-RS-ResourceSet including a higher layer parameter trs-Info, and if applicable, QCL-TypeD with the same CSI-RS resource, or
QCL-TypeA with a CSI-RS resource of configured NZP-CSI-RS-ResourceSet including a higher layer parameter trs-Info, and if applicable, QCL-TypeD with a CSI-RS resource in configured NZP-CSI-RS-ResourceSet including a higher layer parameter repetition, or

QCL-TypeC with a SS/PBCH block, and if applicable, QCL-TypeD with the same SS/PBCH block.

For a DMRS of a PDCCH, UE may expect a TCI state to indicate one of the following QCL type(s).
QCL-TypeA with a CSI-RS resource of configured NZP-CSI-RS-ResourceSet including a higher layer parameter trs-Info, and if applicable, QCL-TypeD with the same CSI-RS resource, or

QCL-TypeA with a CSI-RS resource of configured NZP-CSI-RS-ResourceSet including a higher layer parameter trs-Info, and if applicable, QCL-TypeD with a CSI-RS resource in configured NZP-CSI-RS-ResourceSet including a higher layer parameter repetition, or

QCL-TypeA with a CSI-RS resource of NZP-CSI-RS-ResourceSet configured without a higher layer parameter trs-Info and without a higher layer parameter repetition, and if applicable, QCL-TypeD with the same CSI-RS resource.

For a DMRS of a PDSCH, UE may expect a TCI state to indicate one of the following QCL type(s).
QCL-TypeA with a CSI-RS resource of configured NZP-CSI-RS-ResourceSet including a higher layer parameter trs-Info, and if applicable, QCL-TypeD with the same CSI-RS resource, or
QCL-TypeA with a CSI-RS resource of configured NZP-CSI-RS-ResourceSet including a higher layer parameter trs-Info, and if applicable, QCL-TypeD with a CSI-RS resource in configured NZP-CSI-RS-ResourceSet including a higher layer parameter repetition, or
QCL-TypeA with a CSI-RS resource of NZP-CSI-RS-ResourceSet configured without a higher layer parameter trs-Info and without a higher layer parameter repetition, and if applicable, QCL-TypeD with the same CSI-RS resource.

Uplink/Downlink Transmission or Reception Based on Beam Linkage State

Hereinafter, various examples of the present disclosure for uplink/downlink (UL/DL) transmission or reception based on a beam linkage state (BLS) are described.

A spatial parameter (or a parameter related to beam transmission/reception) related to downlink transmission/reception may include QCL information applied to a physical channel through which downlink control information or data is transmitted and received or assumed by the terminal. The QCL information may include QCL reference signal (RS) information, and the QCL RS information may be configured for each QCL type (e.g., QCL type A/B/C/D). For example, downlink control information (DCI) may be transmitted and received through PDCCH, and a spatial parameter related to DCI transmission/reception may include QCL reference information for PDCCH DMRS antenna port(s), TCI state information, etc. In addition, downlink data may be transmitted and received through PDSCH, and a spatial parameter related to downlink data transmission/reception may include QCL reference information for PDSCH DMRS antenna port(s), TCI state information, etc.

However, in the present disclosure, the term spatial parameter is not limited to QCL information and may include a spatial parameter applied to uplink transmission (e.g., spatial relation info related to an uplink transmission beam). For example, uplink control information (UCI) may be transmitted/received through PUCCH and/or PUSCH, and a spatial parameter related to UCI transmission/reception may include PRI (PUCCH resource indicator), spatial relation info related to PUCCH/PUSCH transmission/reception, or QCL reference RS related to thereof, etc.

In addition, a spatial parameter may be separately set for downlink or uplink, or may be configured integrally for downlink and uplink.

In addition, a spatial parameter may also be defined or configured as a spatial parameter set including at least one spatial parameter. Hereinafter, in order to simplify the description, at least one spatial parameter is collectively referred to as a spatial parameter.

In order for a base station to configure/indicate a PDCCH reception spatial parameter (or reception beam) of a terminal, a TCI state ID may be configured/updated for each of at least one CORESET. A TCI state configured for a CORESET may indicate QCL reference information (e.g., QCL type D related information) for PDCCH DMRS antenna port(s) transmitted through a corresponding CORESET. In other words, QCL reference information (e.g., QCL type D information) of a TCI state ID configured/updated for each CORESET may correspond to a PDCCH reception beam of a terminal.

For a spatial parameter (or reception beam) configuration/indication for PDSCH reception, a TCI field may be included in PDCCH DCI scheduling a corresponding PDSCH. A TCI state ID (or a TCI codepoint) indicated by a TCI field in DCI may indicate QCL reference information (e.g., QCL type D related information) for PDSCH DMRS antenna port(s).

A configuration/indication of a spatial parameter for PDSCH reception may be dynamically performed through DCI, but a spatial parameter indicated through DCI is limited to spatial parameter candidates which are preconfigured through higher layer signaling (e.g., RRC/MAC CE), so higher layer signaling is required for changing/updating a spatial parameter for PDSCH reception. As a spatial parameter for PDCCH reception is based on a CORESET configuration, RRC reconfiguration or MAC CE message transmission, etc. for CORESET configuration/update are required to configure/indicate a spatial parameter for PDCCH reception. In addition, when spatial parameter information (e.g., a TCI field) is not included in DCI scheduling a PDSCH, a spatial parameter for PDSCH reception may be applied based on a spatial parameter configured for a CORESET that corresponding DCI is monitored. In addition, although spatial parameter information (e.g., a TCI field) is included in DCI scheduling a PDSCH, when a time interval (or a scheduling offset) between a time when DCI/PDCCH scheduling a PDSCH is received and a time when a corresponding PDSCH is received is equal to or less than a predetermined threshold, a spatial parameter for PDSCH reception may be applied based on a default spatial parameter (e.g., a TCI state associated with a SS set or a CORESET having a lowest identifier in a latest slot monitored by a terminal). As such, when change/update for a PDCCH/PDSCH spatial parameter/reception beam is performed through higher layer signaling (e.g., RRC/a MAC CE), flexibility is not only reduced, but there is also a disadvantage of an unnecessary signaling overhead according to the change/update.

To resolve such a problem, in the following examples, UL/DL transmission or reception based on a beam linkage state (BLS) is described while minimizing a signaling overhead.

In the following description, spatial parameter or spatial relation info may mean including RS information/QCL related (or reference) RS information/QCL parameters, or the like for spatial related assumption for data/signal transmitted/received through UL channel/DL channel, or may be expressed by being mixed/replaced by the above terms.

In the following examples, the meaning of using/applying/mapping a specific spatial parameter (or TCI state or TCI) when transmitting/receiving data/DCI/UCI for a certain frequency/time/spatial resource is that in the case of DL estimating a channel from DMRS using the QCL type and QCL RS indicated by the corresponding spatial parameter in corresponding frequency/time/spatial resources and receiving/demodulating data/DCI (e.g., PDSCH/PDCCH) with the estimated channel and in the case of UL transmitting/modulating DMRS and data/UCI (e.g., PUSCH/PUCCH) using transmission beam and/or transmission power indicated by the corresponding spatial parameter in corresponding frequency/time/spatial resources.

Hereinafter, various examples of the present disclosure for UL/DL transmission or reception based on a BLS for a case in which a plurality of cells (or serving cells) are configured for a terminal (e.g., for a terminal that carrier aggregation (CA) is configured) are described. One cell may be configured with at least one downlink component carrier (DL CC) and at least 0 uplink CC (UL CC). For example, one cell may be also configured with a plurality of DL CCs and at least 0 UL CC. In addition, at least one BWP may be configured in one cell and one BWP may be activated simultaneously for a terminal, but a scope of the present disclosure does not exclude a case in which a plurality of BWPs are activated simultaneously for a terminal. In the following examples, a term of “cell” may be expressed as a term of CC/BWP for simplicity of a description, but a scope of the present disclosure is not limited to a case in which one cell includes only one CC or only one BWP is activated in one cell.

As described for the above-described downlink beam management and PDCCH reception beam configuration/update, in order to update TCI state information of a CORESET configuration or configure/update a PDSCH reception beam, RRC reconfiguration or MAC-CE message transmission is needed. In addition, as described for the above-described uplink beam management and PUCCH/PUSCH beam configuration/update, RRC reconfiguration or MAC-CE message transmission for a spatial relation is needed for uplink beam configuration/update. In other words, in order to configure/update a spatial parameter for application/use for beam management and reference signal (RS)/Channel (CH) transmission or reception of a terminal (i.e., a transmission/reception parameter (Tx/Rx parameter) in a spatial domain), it is performed through a RRC reconfiguration of spatial relation info or a TCI state or a MAC-CE message is required. Accordingly, there is a problem that flexibility for uplink/downlink transmission or reception beam update is not only reduced, but also an unnecessary signaling overhead according to such update is caused.

In order to reduce an overhead of uplink beam change/update of a terminal, as an example of an operation which interlocks an uplink beam RS with a downlink beam RS for spatial relation info of a PUCCH/a PUSCH/a SRS, a default spatial relation may be defined.

For example, when a CORESET is configured in an active BWP of a corresponding DL CC, a terminal may configure a QCL Type-D RS corresponding to a lowest CORESET ID as a default spatial relation. If any CORESET is not configured in a corresponding DL BWP, a terminal may configure a QCL Type-D RS indicated in a TCI state corresponding to a lowest ID among TCI state(s) for an activated PDSCH as a default spatial relation.

When a PUCCH exists in an UL CC/BWP, at least one CORESET exists in a corresponding DL CC/BWP, so a QCL Type-D RS corresponding to a lowest CORESET ID may be configured as a default spatial relation for a PUCCH and a default spatial relation configuration based on TCI state(s) for a PDSCH may not be applied. For a PUSCH, a default spatial relation may be applied to a PUSCH scheduled by fallback DCI (e.g., DCI format 0_0). In addition, when there is no PUCCH configured in a corresponding UL BWP (e.g., SCell UL) or when a default beam for a PUCCH is enabled in a state when a spatial relation for a PUCCH is not configured although a PUCCH is configured (e.g., when enableDefaultBeamPlForPUCCH, a RRC parameter based on UplinkConfig information element, is configured to be enabled), a default spatial relation operation may be performed. In this case, a terminal may configure a TCI state/a QCL assumption corresponding to a lowest CORESET ID of a DL CC/a BWP scheduling a PUSCH as a default spatial relation.

For such a default beam related operation, a limit that a transmission beam is a TCI of a lowest CORESET ID or is connected only to a lowest ID among TCI states for a PDSCH is applied, so there is a problem that it is difficult to flexibly indicate a UL/DL integrated spatial parameter. In particular, there is a problem that flexibility of spatial parameter configuration/update is low when multiple CCs/BWPs are configured and that a signaling overhead increases for configuring/updating a variety of spatial parameters.

For example, when spatial parameter configuration/update/activation for any one CC/BWP among a plurality of CCs/BWPs is indicated, configuration/update/activation of a corresponding spatial parameter may be also applied to other CC/BWP. Hereinafter, such an operation is referred to as simultaneous spatial parameter update. According to such an operation, repeat transmission of a control signal according to a configuration per CC may be prevented by commonly applying one spatial parameter to a plurality of CCs/BWPs, but an independent operation should be performed for each transmission/reception spatial parameter indication and integrated spatial parameter change/update is not supported for other RS(s) and/or channel(s) other than a target CH/RS. Accordingly, as the number of configured CCs/BWPs increases (e.g., up to 32 CCs may be configured for one terminal), it becomes a problem in terms of a signaling overhead and flexibility for uplink/downlink spatial parameter change. In addition, when a spatial parameter for a specific RS/CH is indicated through UL/DL DCI, there is a problem that a size of a spatial parameter indication field of DCI should be increased and a payload size of DCI increases.

To resolve it, according to the present disclosure, a transmission or reception spatial parameter changed/updated in a simultaneous spatial parameter update process for multiple CCs/BWPs may be defined as a spatial parameter for reference transmission or reception (hereinafter, a reference spatial parameter) and a spatial parameter for target transmission or reception (e.g., a RS/a CH) in at least one CC/BWP of multiple CCs/BWPs (i.e., a target spatial parameter) may be changed/updated based on a BLS. In other words, based on a reference spatial parameter, a spatial parameter for target transmission or reception may be changed/updated based on a BLS configured for a corresponding CC/BWP.

In addition, a BLS which defines a spatial parameter linkage relation between reference transmission or reception and target transmission or reception may be configured per CC/BWP or per CC/BWP group. A linkage relation and scope of a spatial parameter between reference transmission or reception and target transmission or reception may be dynamically indicated based on a BLS.

A configuration for a BLS may include a configuration for at least one candidate of a BLS and an indication for one specific BLS of the at least one BLS candidate. A configuration for a BLS may be provided from a base station to a terminal through higher layer (e.g., RRC) signaling. An indication for one specific BLS of BLS candidates may be provided from a base station to a terminal through a MAC-CE or DCI.

A BLS may include information on a mapping relation between at least one reference transmission or reception and at least one target transmission or reception. For example, each BLS candidate may define a mapping relation between one reference transmission or reception and at least one target transmission or reception. A BLS may define a relation that a first spatial parameter for reference transmission or reception and a second spatial parameter for target transmission or reception are linked (e.g., a second spatial parameter is changed according to a change in a first spatial parameter).

Here, a second spatial parameter may be a spatial parameter which is the same as a first spatial parameter or corresponds to a first spatial parameter. For example, a reception spatial parameter (or a reception beam) of a terminal and a transmission spatial parameter (or a transmission beam) of a terminal may have a corresponding relation according to implementation of a transmission or reception filter of a terminal. Alternatively, a first reception spatial parameter (or reception beam) of a terminal may have a corresponding relation with a second reception spatial parameter (or reception beam) and a first transmission spatial parameter (or transmission beam) of a terminal may have a corresponding relation with a second transmission spatial parameter (or transmission beam).

For example, such a corresponding relation between a first and second spatial parameter may be predefined/predetermined according to a predetermined rule or may be preconfigured by signaling exchange between a base station and a terminal, or may be predefined according to implementation of a terminal. Accordingly, a specific corresponding relation between spatial parameters is not defined in the present disclosure and a variety of random corresponding relations may be applied. In other words, in examples of the present disclosure, it is assumed that a corresponding relation between a first and second spatial parameter is known in advance to a terminal and/or a base station.

In addition, a terminal may receive from a base station information on a specific BLS which is activated or valid among at least one candidate of a BLS.

For example, information on a specific BLS may be indicated to a terminal through higher layer (e.g., a MAC CE) or lower layer (e.g., DCI) signaling.

Accordingly, a terminal may determine target transmission or reception(s) mapped to reference transmission or reception based on a specific BLS. For example, reference transmission or reception may be a first UL/DL reference signal (RS)/channel (CH) and target transmission or reception may be a second UL/DL RS/CH. For example, a DL RS/CH may be a PDCCH, a PDSCH, a SSB, a CSI-RS, etc. and a UL RS/CH may be a PUCCH, a PUSCH, a SRS, etc.

Accordingly, spatial relation info as well as a TCI state may be utilized as a reference spatial parameter, so association flexibility for a transmission or reception spatial parameter determination may be improved. In addition, through spatial parameter change/update based on a linkage relation for a spatial parameter, a dynamic transmission or reception spatial parameter indication is possible, so compared with a spatial parameter/beam indication method which is independently performed, there is an advantage that a signaling overhead is not only reduced, but also a spatial parameter/beam configuration/indication related field in DCI according to a specific linkage relation may be omitted.

In order to prevent a collision between a simultaneous spatial parameter update/activation operation along with the existing transmission or reception spatial parameter/beam configuration/update and a spatial parameter configuration/update operation based on a BLS for multiple CCs/BWPs according to the present disclosure, an enabler for a spatial parameter configuration/update operation based on a BLS for multiple CCs/BWPs according to the present disclosure may be defined. In other words, examples of the present disclosure may be applied to a case in which it is indicated that the enabler parameter is enabled. For example, a parameter (e.g., beam_linkage_multiCC_enabler) for whether a spatial parameter/beam configuration/update operation through application of BLS information considering multiple CCs/BWPs is enabled may be configured in a RRC configuration and if a corresponding enabler is ‘ON’, examples of the present disclosure (e.g., embodiment 1/2/3) may be activated. If a corresponding enabler is ‘OFF’, the existing operation may be followed.

FIG. 15 is a flow chart for describing a method in which a terminal performs uplink transmission or downlink reception based on a beam linkage state according to the present disclosure.

In S1510, a terminal may receive from a base station configuration information on a first beam linkage state (BLS) for a first resource and a second BLS for a second resource.

Each of a first and second BLS may include information on a mapping relation between reference transmission or reception and at least one target transmission or reception. In addition, the first BLS may be configured to be the same as or different from the second BLS. A first BLS or a second BLS may not be directly configured or may be configured based on a BLS configured for a third resource of a resource group to which a first resource or a second resource belongs.

Here, a resource may be configured based on at least one of a component carrier (CC), a CC list, a bandwidth part (BWP), or a band configured for the terminal.

In addition, information (e.g., an enabler) on whether the downlink reception or uplink transmission by a terminal is performed based on the BLS may be provided from the base station.

In S1520, a terminal may receive from a base station reference spatial parameter indication information for reference transmission or reception for a first resource.

For example, indication information may indicate a reference spatial parameter which is simultaneously applied to the first resource and the second resource. In other words, the indication information may include information on a reference spatial parameter which is changed/updated according to a simultaneous spatial parameter update operation. A reference spatial parameter may be a spatial parameter which is applied to reference transmission or reception configured by a BLS.

When reference transmission or reception is downlink reception, a reference spatial parameter may be indicated by a TCI state. When reference transmission or reception is uplink transmission, a reference spatial parameter may be indicated by spatial relation information (spatial relation info).

In S1530, a terminal may perform uplink transmission or downlink reception on a second resource based on a target spatial parameter for specific target transmission or reception.

Specific target transmission or reception may be one target transmission or reception among at least one target transmission or reception mapped to the reference transmission or reception based on a second BLS.

A target spatial parameter may be determined based on a reference spatial parameter. For example, a target spatial parameter may be a spatial parameter corresponding to a reference spatial parameter for a second resource. More specifically, at least one target spatial parameter candidate corresponding to a reference spatial parameter may be determined and one specific target spatial parameter may be determined among at least one target spatial parameter candidate. For example, one specific target spatial parameter may be determined as a spatial parameter according to a predefined rule (e.g., corresponding to a lowest or highest identifier), or may be determined as a spatial parameter indicated by downlink control information (DCI) related to uplink transmission or downlink transmission. In addition, a corresponding relation between a reference spatial parameter and a target spatial parameter may be predetermined.

FIG. 16 is a flow chart for describing a method in which a base station performs uplink reception or downlink transmission based on a beam linkage state according to the present disclosure.

In S1610, a base station may transmit to a terminal configuration information on a first beam linkage state (BLS) for a first resource and a second BLS for a second resource.

A description related to S1510 in FIG. 15 may be equally applied to a resource and a BLS configuration.

In S1620, a base station may transmit to a terminal reference spatial parameter indication information for reference transmission or reception for a first resource.

A description related to S1520 in FIG. 15 may be equally applied to reference transmission or reception and a reference spatial parameter indication.

In S1630, a base station may perform uplink reception from a terminal or downlink transmission to a terminal on a second resource.

Here, a base station may expect that a terminal will apply a target spatial parameter based on a BLS and a simultaneous spatial parameter update operation for multiple resources (e.g., multiple CCs/BWPs). For example, downlink transmission of a base station on a second resource may be received by a terminal based on a target spatial parameter for specific target transmission or reception among at least one target transmission or reception. Uplink reception of a base station on a second resource may be transmitted by a terminal based on a target spatial parameter for specific target transmission or reception among at least one target transmission or reception.

A description related to S1530 in FIG. 15 may be equally applied to target transmission or reception and a target spatial parameter.

In an example of FIG. 15 and FIG. 16, reference transmission or reception or target transmission or reception may be configured as a predetermined UL/DL RS/CH or may be configured based on a UL/DL RS/CH type. For example, for reference transmission or reception or target transmission or reception, a UL/DL RS/CH type may be defined based on at least one of usage, contents, a format, a type or a time domain characteristic of a UL/DL RS/CH.

Hereinafter, various examples of the present disclosure for BLS based UL/DL transmission or reception for multiple CCs/BWPs are described.

### Embodiment 1

This embodiment is about a method in which a base station configures BLS information for multiple CCs/BWPs for a terminal. For example, a base station may configure BLS information on multiple CCs/BWPs through higher layer (e.g., RRC) signaling.

For example, a BLS may be configured in a unit of at least one of a CC, a CC group, or a band. In addition, the same or different BLS information may be configured for at least one of different CCs, CC groups, or bands.

First, an example in which a BLS is configured in a unit of a CC is described. In the following description, a CC as a unit that a BLS is configured may be replaced with a CC group, a band or a combination thereof.

For example, when a BLS configuration is not signaled by a base station for a specific CC, BLS information configured for other CC (e.g., a CC included in the same CC group (or list or set)) associated with the specific CC may be defined to be applied to the specific CC. It may be said that a common BLS is applied across a plurality of CCs. If a plurality of other CCs are associated with the specific CC, a BLS of specific one (e.g., a CC with a lowest or highest CC index) among CCs that a BLS is configured among the plurality of other CCs may be applied to the specific CC.

As an additional example, when a BLS configuration is not signaled by a base station for a specific CC, it may be defined that a predefined BLS is applied. A predefined BLS may be a BLS whose BLS ID (or BLS candidate ID) is 0 or may correspond to no definition of a BLS (no beam linkage).

As an additional example, when target transmission or reception indicated in a BLS configured for a DL only CC (i.e., a target RS/CH) includes UL RS(s)/CH(s), the BLS may be applied only to the remaining RS(s)/CH(s) excluding corresponding UL RS(s)/CH(s) (e.g., DL RS(s)/CH(s)). In other words, a terminal may not expect to receive a configuration/an indication for a BLS in which UL target transmission or reception is included in a DL only CC.

Similarly, when target transmission or reception indicated in a BLS configured for a UL only CC (i.e., a target RS/CH) includes DL RS(s)/CH(s), the BLS may be applied only to the remaining RS(s)/CH(s) excluding corresponding DL RS(s)/CH(s) (e.g., UL RS(s)/CH(s)). In other words, a terminal may not expect to receive a configuration/an indication for a BLS in which DL target transmission or reception is included in a UL only CC.

In addition, based on a reference spatial parameter which is changed/updated by simultaneous spatial parameter update for a plurality of CCs, a spatial parameter for target transmission or reception in a corresponding CC/BWP may be changed/updated. Here, a linkage relation between a reference spatial parameter and a target spatial parameter in a corresponding CC/BWP may follow a BLS configured for a corresponding CC/BWP.

For example, a BLS according to DL spatial parameter change/update and a BLS according to UL spatial parameter change/update may be configured independently or may be integrated and configured. In the following examples, it is assumed that a BLS is applied independently for a DL/UL for clarity of a description, but a scope of the present disclosure is not limited thereto, and may also include a case in which a BLS is applied by DL/UL integration.

Information related to a PDSCH reception beam and an ACK/NACK PUCCH transmission beam for a corresponding PDSCH may be indicated respectively through a PRI (PUCCH resource indicator) field and a TCI (transmission configuration indication) field of the existing DCI format 1_1. When a BLS is applied, a PUCCH transmission beam may be determined by applying a spatial Tx parameter corresponding to a spatial Rx parameter utilized in PDSCH reception. Accordingly, a BLS may apply a transmission or reception beam indication of other RS(s)/CH(s) based on a reference change/update transmission or reception beam per each state and may also configure a scope for corresponding application. For example, when a TCI state ID for CORESET #1 is changed/updated through a MAC-CE in a specific CC, a BLS may be configured to change all CORESET beams with a corresponding TCI state ID or to be applied to a PDSCH beam and/or a specific PUCCH (e.g., a SR PUCCH/an A/N PUCCH/a CSI PUCCH, etc.)/PUSCH, etc. As an embodiment of a configuration for a BLS, BLS #1={PDCCH, A/N PUCCH, PUSCH} may be configured. In other words, reference spatial parameter information (e.g., a reference TCI state ID) which is a reference for change/update may be configured and indicated based on higher layer signaling (e.g., RRC/a MAC-CE, etc.) and a target spatial parameter (associated with a reference spatial parameter) may be applied to target transmission or reception (RS/CH) determined by a BLS (i.e., associated with reference transmission or reception).

For example, a BLS which defines a spatial parameter linkage relation between reference transmission or reception and target transmission or reception may be defined as shown in an example of Table 9. Table 9 is just an example, and does not limit a technical scope of the present disclosure. Accordingly, a BLS may be defined by a rule in a form different from an example of Table 9.

In reference to FIG. 9, whether a spatial parameter between transmission or reception (a PDSCH, an ACK/NACK PUCCH, all configured PUCCHs, PUSCHs, PDCCHs) is linked may be represented as 0 (i.e., not linked) and 1 (i.e., linked).

TABLE 9

| BLS | PDSCH | ACK/NACK PUCCH | All Configured PUCCH | PUSCH | PDCCH |
|---|---|---|---|---|---|
| #1 | 1 | 1 | 0 | 0 | 0 |
| #2 | 0 | 0 | 1 | 0 | 0 |
| #3 | 1 | 0 | 0 | 1 | 0 |
| #4 | 0 | 0 | 0 | 0 | 1 |
| #5 | 1 | 1 | 0 | 1 | 0 |
| #6 | 0 | 1 | 0 | 0 | 1 |
| #7 | 1 | 0 | 1 | 1 | 0 |
| #8 | 0 | 0 | 1 | 0 | 1 |
| #9 | 1 | 1 | 0 | 1 | 1 |
| #10 | 0 | 0 | 1 | 1 | 1 |

In relation to a BLS, a reference spatial parameter (e.g., a reference TCI state ID, a reference spatial relation info ID) may be configured/indicated in advance through higher layer signaling (e.g., RRC/a MAC-CE, etc.).

For example, when BLS #6 is configured/indicated in an example of Table 9, a spatial parameter between an ACK/NACK PUCCH and a PDCCH may be linked. For example, a PDCCH may be reference transmission or reception, target transmission or reception may be an ACK/NACK PUCCH and a reference spatial parameter for a PDCCH, reference transmission or reception, (e.g., a reference TCI state ID) may be configured/indicated in advance. When a simultaneous spatial parameter update operation is performed, a spatial Rx parameter for PDCCH reception may be changed/updated to a spatial Rx parameter of a TCI state ID configured according to simultaneous spatial parameter update and a spatial Tx parameter for an ACK/NACK PUCCH may be changed/updated to a spatial Tx parameter corresponding to a spatial Rx parameter of the TCI state ID.

In Table 9, it was described by taking an ACK/NACK PUCCH as an example, but for a PUCCH, there are a variety of types according to its purpose/usage, so a PUCCH that a linkage relation is defined by a BLS is not limited to an ACK/NACK PUCCH. For example, a linkage relation for PUCCH type A and PUCCH type B may be defined by a BLS. PUCCH type(s) may be predefined or may be configured to be explicitly distinguished according to a predetermined standard. For example, a PUCCH type may be distinguished based on usage/contents/format of a PUCCH, whether it is a dedicated PUCCH and others.

For example, when a type is distinguished based on PUCCH usage, TypeA may correspond to a PUCCH for scheduling request (SR)/HARQ-ACK/CSI transmission and TypeB may correspond to a PUCCH for a beam failure recovery request (BFRQ).

For example, when a type is distinguished based on a PUCCH format, TypeA may correspond to a short PUCCH (e.g., PUCCH format 0, 2) and TypeB may correspond to a long PUCCH (e.g., PUCCH format 1, 3, 4).

For example, when a type is distinguished based on whether it is a dedicated PUCCH, TypeA may correspond to a common (or non-dedicated) PUCCH of a terminal for HARQ-ACK for Msg4 of a RACH procedure (i.e., a competition resolution message) and TypeB may correspond to a dedicated PUCCH (or terminal-specific) PUCCH.

In other words, reference transmission or reception and target transmission or reception defined by a BLS may be distinguished in a unit of a RS/CH or may be additionally distinguished in a unit of a RS/CH type.

As an additional example, transmission or reception that a linkage may be configured by a BLS (i.e., reference transmission or reception or target transmission or reception) may include a PRACH, a SRS, a CSI-RS, etc. other than a PUCCH, a PUSCH, a PDCCH and a PDSCH. In this case, for at least one of a PRACH, a SRS, or a CSI-RS, a BLS may be configured for at least one of a RS unit, a resource type unit, or a RS resource unit.

The above-described examples may include that a BLS is configured equally or differently for multiple CCs/BWPs.

When a BLS is configured differently per CC, it may mean that mapping with a BLS is possible for each CC of multiple CCs. In other words, one BLS corresponding to one CC may be indicated/configured. For example, a pair of a CC index and a BLS index may be indicated/configured. For example, in a situation where 10 CCs are considered, it may be configured by a method such as {CC index, beam linkage state index}={(1, 1), (2, 2), (3, 4), _, (9, 5), (10, 7)} and so on.

When a BLS is configured differently per CC list (or group or set), it may mean that mapping with a BLS is possible for a CC list (e.g., one CC list includes at least one CC). For example, for a set of up to 2 CC(s) utilized in simultaneous spatial parameter update, each BLS may be associated/mapped. For example, a pair of a CC list index and a BLS index may be indicated/configured. For example, in a situation where 10 CCs are considered, it may be configured by a method such as CC list #1={CC1, CC3, CC5, CC7, CC9}, CC list #2={CC2, CC4, CC6, CC8, CC10} and {CC list index, beam linkage state index}={(1, 5), (2, 7)} and so on. In this case, all CCs belonging to each CC list may follow corresponding (same one) BLS configuration/indication. In addition, a different CC list may include different CCs and all or part of CCs in a different CC list may be overlapped.

When a BLS is configured differently per band, based on a frequency band (e.g., a NR band) applied to CC(s) configured for a terminal, it may correspond to considering CC(s) belonging to the same band as one CC group in an implicit way. In other words, CC(s) belonging to the same band may be interpreted as intra-band carrier aggregation (CA), and may be interpreted as inter-band CA between different bands. Accordingly, not only may a CC list be determined through a CC designated through a MAC-CE message, but also a band to which a corresponding CC belongs and a band to which a corresponding CC does not belong may be distinguished. Accordingly, other CC(s) in a band that a CC which is changed/updated is included may apply a BLS that more linkage scopes are applied to common beam operation and may apply only a simultaneous spatial parameter update operation or may apply a BLS whose linkage scope is relatively reduced and applied to a CC other than a corresponding band. As such, a different BLS configuration may be applied per band.

For example, it may be assumed that BLS #1 is configured for intra-band CA and BLS #2 is configured for inter-band CA. In this case, when spatial parameter update for CC #3 is configured/indicated in a MAC-CE for simultaneous spatial parameter update, it may be determined that simultaneous spatial parameter update is performed for CC list #1 including CC #3 among predetermined CC lists (e.g., CC list #1={CC1, CC3, CC5, CC7, CC9}, CC list #2={CC2, CC4, CC6, CC8, CC10}). In this case, if there is an implicit CC group that CC index 1, 3, 5 belong to band #1 and CC index 7, 9 belong to band #2, BLS #1 may be applied to CC index 1, 3, 5 belonging to an intra-band and BLS #2 may be applied to CC index 7, 9 for CC #3 of a MAC-CE. If spatial parameter update for CC #9 is configured/indicated in a MAC-CE, simultaneous spatial parameter update may be performed for CCs belonging to CC list #1, BLS #1 may be applied to CC index 7, 9 among CCs belonging to CC list #1 and BLS #2 may be applied to CC index 1, 3, 5.

As an additional example, CC/BWP list information and/or CORESET ID(s) which may be applied to BLS configuration information may be included. In other words, when a BLS is configured/indicated, CC(s)/BWP(s) to which a corresponding BLS is applied may be separately configured per BLS. In addition, CORESET ID(s) of BWP(s) in a CC utilized for a PDCCH reception beam may be separately configured per BLS. In this case, when there are no specific CORESET ID(s) in BWP(s) in a CC that a corresponding BLS is configured or when there is no CORESET configuration, spatial parameter (e.g., TCI state) update may not be applied to corresponding BWP(s). Alternatively, a terminal may not expect that a CORESET ID other than CORESET ID(s) commonly configured for all BWP(s) in a CC are configured as a target of spatial parameter update or are included in a BLS configuration.

For example, the above-described examples may be performed through a BLS configuration/indication through a MAC-CE. In other words, together with TCI state activation or spatial relation update through a MAC-CE, a specific ID for a BLS may be indicated. Accordingly, until there is an indication through the following MAC-CE after a specific time (e.g., an applicable timing, etc.), a spatial parameter may be changed/updated according to an indicated method. In addition, a specific field of DCI (e.g., a TCI field, a PRI field, etc.) may be omitted according to a specific BLS.

### Embodiment 2

This embodiment is about a method in which a target spatial parameter is determined based on a BLS for multiple CCs/BWPs when a reference spatial parameter is TCI state(s).

For example, a terminal may change/activate/indicate RS information for deriving a spatial Tx/Rx parameter for a plurality of CCs/BWPs by utilizing TCI state(s) activated through simultaneous spatial parameter (e.g., TCI state) update. In other words, when specific TCI state ID(s) are activated as a base station indicates simultaneous spatial parameter update to a terminal through a MAC-CE, a terminal may determine a transmission or reception spatial parameter for target RS(s)/CH(s) by using activated TCI state(s) (or based on activated TCI state(s)).

A TCI state subject to simultaneous spatial parameter update for multiple CCs/BWPs (i.e., a reference spatial parameter) may be equally/differently determined per CC/BWP.

As a first example, both a QCL Type-A and Type-D RS may be changed to a RS included in an indicated/activated TCI state ID.

As a second example, only a QCL Type-D RS may be changed to a RS included in an indicated/activated TCI state ID.

As a third example, the same TCI state ID may be activated/indicated in corresponding CC(s).

When a TCI state for a PDCCH/a PDSCH is indicated/activated through a MAC-CE and/or DCI, a QCL Type-D RS or a spatial relation RS for target RS(s)/CH(s) indicated by a BLS preconfigured through RRC may be applied as a corresponding indicated/activated TCI state (i.e., a TCI state indicated/activated through a MAC-CE/DCI). It may mean that a TCI state (or a spatial parameter or QCL information) indicated/activated through a MAC-CE/DCI takes priority over a TCI state (or a spatial parameter or QCL information) of a BLS configured through RRC. Alternatively, whether an indicated/activated TCI state is applied only to a target RS/CH corresponding to an indication/activation message may be additionally configured/indicated through a separate indicator.

A simultaneous spatial parameter update operation may include TCI state activation for a reception beam and spatial relation update for a transmission beam. For reception beam change/update from a downlink perspective, a TCI state set for a PDSCH (e.g., configured with up to 8 TCI state IDs) or a TCI state ID for a CORESET may be indicated through a MAC-CE. Specific examples of a resulting beam change/update method are described below.

### Embodiment 2-1

According to a simultaneous spatial parameter update operation, when a set of TCI state IDs for a PDSCH is activated through a MAC-CE for a specific CC, the set of TCI state IDs for a PDSCH may be also activated for other CC(s) belonging to a CC list in which the specific CC is included as well as the specific CC. Here, for the specific CC and the other CC(s), Tx/Rx spatial parameter related information for (other) target RS(s)/CH(s) preconfigured by a BLS as well as a set of TCI state IDs for a PDSCH may be changed/updated (together). In other words, a set of TCI state IDs for a PDSCH activated/indicated by simultaneous spatial parameter update may correspond to the above-described reference spatial parameter and a target spatial parameter of a target RS/CH liked by a BLS and reference transmission or reception to which the reference spatial parameter is applied may be also changed/updated based on a reference spatial parameter.

In relation to activation of a TCI state candidate group, all or part of a set of TCI state IDs (or QCL Type-D RS(s) indicated by a set of TCI state IDs) may be activated as candidate(s) of QCL Type-D RS(s)/spatial relations RS(s) for target RS(s)/CH(s) of a BLS (i.e., a target spatial parameter). In this case, a QCL Type-D RS/spatial relation RS which will be applied to each target RS/CH transmission or reception may be separately indicated. Similarly, candidate(s) of a target spatial parameter may be also activated for other RS(s)/CH(s) liked by a BLS.

In relation to an indication of a specific TCI state, a RS (e.g., QCL Type-D RS(s)) corresponding to one specific TCI state ID of a set of TCI state IDs (or QCL Type-D RS(s) indicated by a set of TCI state IDs) may be used as a RS for deriving a spatial Tx/Rx parameter for a target RS/CH (e.g., a QCL Type-D RS for a DL RS/CH, a spatial relation RS for an UL RS/CH). The one specific TCI state may be determined based on a predefined rule or other indication information. If the one specific TCI state is determined, a resulting RS or indicator application method may change/update both QCL Type-A and QCL Type-D, or may change/update only a QCL Type-D RS, or may follow the above-described example which activates/indicates the same TCI state ID in corresponding CC(s) that the specific TCI state ID is indicated.

For example, the one specific TCI state may be determined as a TCI state corresponding to a predefined rule (e.g., a lowest or highest TCI state ID) among TCI state candidate (s).

As an additional example, the one specific TCI state may be determined as a TCI state corresponding to a TCI codepoint indicated by a TCI field included in DCI (e.g., DCI format 1_1).

In relation to a TCI state application scope, when all or part of a set of TCI state IDs are separately indicated as a spatial parameter which will be applied to target RS/CH transmission or reception or when one specific TCI state is determined, an application scope of RS(s) for a corresponding TCI state (i.e., a TCI state as a reference spatial parameter) may follow the following examples.

When a target RS/CH includes a PUCCH (or a SR PUCCH, an ACK/NACK PUCCH, a CSI PUCCH), a spatial parameter based on RS(s) of a corresponding reference TCI state may be applied to a spatial relation RS for all PUCCH resources. Alternatively, a spatial parameter based on RS(s) of a corresponding reference TCI state may be applied to a spatial relation RS for a PUCCH resource group per usage of a target PUCCH, i.e., for a SR PUCCH, an ACK/NACK PUCCH, a CSI PUCCH.

When a target RS/CH includes a SRS, a spatial parameter based on RS(s) of a corresponding reference TCI state may be applied to a spatial relation RS for a SRS resource per usage of a SRS (e.g., beam management (BM), codebook based (CB), Non-codebook based (non-CB), antenna switching (AS)) and/or per time domain characteristic of a SRS (e.g., periodic/semi-static/aperiodic). For example, usage/time domain characteristic of a SRS may be configured based on higher layer signaling (e.g., a SRS-Resourceset parameter of a SRS-Config information element).

When a target RS/CH includes a CSI-RS, a spatial parameter based on RS(s) of a corresponding reference TCI state may be applied to a spatial relation RS for a CSI-RS resource per usage of a CSI-RS (e.g., BM, TRS, CSI acquisition) and/or per time domain characteristic of a CSI-RS (e.g., periodic/semi-static/aperiodic). For example, usage for a CSI-RS may be configured based on higher layer signaling (e.g., CSI report config) and a time domain characteristic for a CSI-RS may be configured based on higher layer signaling (e.g., CSI-ResourceConfig or CSI report config).

Examples of embodiment 2-1 correspond to a method of changing/updating a spatial parameter of target RS(s)/CH(s) according to a BLS based on up to 8 TCI state ID(s) activated per CC/BWP through a MAC-CE among up to 128 TCI states configured by a higher layer. Here, a method of indicating reference spatial parameter information is described below.

First, all or part of a set of activated TCI state IDs may be used as a candidate QCL Type-D RS or a candidate spatial relation RS for determining a spatial parameter of target RS(s)/CH(s) configured by a BLS. Here, a QCL Type-D RS/spatial relation RS which will be applied to each target RS/CH may be separately indicated.

For example, when a PUSCH is included in a target RS/CH in a configured BLS, a spatial relation RS which will be applied to actual PUSCH transmission may be separately indicated through DCI for a grant based PUSCH and through RRC/MAC-CE/DCI for a configured grant based PUSCH.

For example, when a PDCCH is included in a target RS/CH in a configured BLS, a QCL Type-D RS which will be applied to actual PDCCH reception may be indicated through DCI of a grant based PDSCH.

As an additional example, when a set of TCI state IDs is activated for a specific CC, a TCI state ID of a CORESET of BWP(s) of the specific CC may be changed/updated. For example, activated TCI state application for a plurality of CORESETs may be performed by one-to-one correspondence between a CORESET ID and a TCI state ID set, or TCI state(s) may be applied to at least one CORESET(s) according to a predefined rule.

As an additional example, after indicating a specific TCI state through a predefined rule for a set of activated TCI state IDs, a BLS based operation may be performed by using reception beam information in the specific TCI state as a reference. Here, a predefined rule may be a TCI state ID mapped to a lowest or highest TCI codepoint. When a plurality of TCI state IDs are associated with a specific (e.g., lowest/highest) TCI codepoint, QCL/spatial relation information indicated by a lowest or highest TCI state ID of them may be determined as a reference spatial parameter. In addition, in order to support a more dynamic spatial parameter indication, a spatial parameter of a TCI state ID corresponding to a TCI codepoint indicated in a TCI field included in DCI format 1_1 may be determined as a reference spatial parameter.

As described above, when all or part of A specific set of TCI state IDs are separately indicated as a QCL Type-D RS/a spatial relation RS which will be applied to a target RS/CH or when one specific TCI state is indicated, an application scope according to a BLS of RS(s) for a corresponding TCI state may be implicitly/explicitly configured.

For example, a scheduling request (SR) means that a terminal requests a UL grant (e.g., DCI format 0 series) to a base station for PUSCH transmission. In this case, a terminal uses a SR PUCCH (e.g., PUCCH format 0 or PUCCH format 1) and a corresponding PUCCH resource may be configured by a higher layer parameter (e.g., a PUCCH-ResourceID (PRI) parameter of a SchedulingRequestResourceConfig information element of RRC). Accordingly, a transmission beam change/indication for a SR PUCCH based on a BLS may be applied to PUCCH resource(s) configured for a SR. Alternatively, a transmission beam change/indication based on a BLS may be applied to all resources for a PUCCH.

For example, for an ACK/NACK PUCCH, in case of DCI format 11, a transmission beam may be determined according to a 3-bit PRI field in a DCI field. A transmission beam change/indication based on a BLS may be applied to corresponding resources for an ACK/NACK PUCCH. Alternatively, a transmission beam change/indication based on a BLS may be applied to all resources for a PUCCH.

For example, for a PUCCH for periodic (P)/semi-static (SP) CSI report, a transmission beam change/indication based on a BLS may be applied to resource(s) for P/SP CSI report. Alternatively, a transmission beam change/indication based on a BLS may be applied to all resources for a PUCCH.

Accordingly, if a PUCCH for specific usage (e.g., a SR PUCCH/an A/N PUCCH/a CSI PUCCH) is configured when performing a PUCCH related configuration based on a BLS, a terminal may expect that a transmission beam is changed/indicated for PUCCH resource(s) for corresponding usage. Alternatively, when targeting all resource(s) for a PUCCH, a terminal may expect that a transmission beam is changed/indicated based on a BLS for a PUCCH.

As an additional example, transmission beam change/update according to a BLS may be applied based on a reference TCI state for resource(s) according to each usage, for resource(s) according to a time domain characteristic (P/SP/Aperiodic (AP)), or for resource(s) simultaneously considering usage and a time domain characteristic for a SRS or a CSI-RS.

As described above, DL reference RS and QCL assumption/information of one specific TCI state ID among TCI state candidate groups may be determined and a terminal may change/update a reference RS of spatial relation info applied to transmission of target UL RS(s)/CH(s) based on the DL reference RS and QCL assumption/information based on a BLS. In addition, reference RS and QCL assumption/information of a TCI state applied to reception of target DL RS(s)/CH(s) may be changed/updated based on the DL reference RS and QCL assumption/information based on a BLS.

### Embodiment 2-2

According to a simultaneous spatial parameter update operation, when a TCI state ID (a TCI-state ID for a CORESET) for a CORESET is indicated through a MAC-CE for a specific CC, the TCI state ID for a CORESET may be also activated for other CC(s) belonging to a CC list in which the specific CC is included as well as the specific CC. Here, for the specific CC and the other CC(s), Tx/Rx spatial parameter related information for (other) target RS(s)/CH(s) preconfigured by a BLS as well as a TCI state ID for a CORESET may be changed/updated (together). In other words, a TCI state ID for a CORESET activated/indicated by simultaneous spatial parameter update corresponds to the above-described reference spatial parameter and a target spatial parameter of a target RS/CH liked by a BLS and reference transmission or reception to which the reference spatial parameter is applied may be also changed/updated based on a reference spatial parameter.

A TCI state subject to simultaneous spatial parameter update for multiple CCs/BWPs (i.e., a reference spatial parameter) may be equally/differently determined per CC/BWP.

As a first example, both a QCL Type-A and Type-D RS may be changed to a RS included in an indicated TCI state ID.

As a second example, only a QCL Type-D RS may be changed to a RS included in an indicated TCI state ID.

As a third example, the same TCI state ID may be activated/indicated in corresponding CC(s) that a TCI state ID is indicated.

As a fourth example, the indicated TCI state may be activated by being included as a candidate TCI state for a CORESET in other CC(s) other than corresponding CC(s) that a TCI state ID is indicated.

When a PDCCH is included in a target RS/CH indicated by a BLS for a CC/BWP where there is no CORESET configuration (e.g., a SCell having a DL CC scheduled in cross carrier scheduling), a BLS may be applied only to the remaining RS(s)/CH(s) excluding a PDCCH. Alternatively, a terminal may not expect to receive an indication on a BLS that a PDCCH is included for a CC/BWP where there is no CORESET configuration.

In BWP(s) of specific CC(s) in a CC list (or group or set), when a CORESET ID indicated by a MAC-CE does not exist and a PDCCH is not included in a target RS/CH indicated by a BLS, TCI state update may not be applied to corresponding BWP(s), or CORESET ID(s) may be selected according to a predefined rule (e.g., as a lowest or highest CORESET ID). Alternatively, a terminal may not expect that a CORESET ID other than CORESET ID(s) commonly configured for all BWP(s) in a CC is configured as a MAC-CE.

A TCI state application scope may be determined as follows.

When a target RS/CH includes a PUCCH (or a SR PUCCH, an ACK/NACK PUCCH, a CSI PUCCH), a spatial parameter based on RS(s) of a corresponding reference TCI state may be applied to a spatial relation RS for all PUCCH resources. Alternatively, a spatial parameter based on RS(s) of a corresponding reference TCI state may be applied to a spatial relation RS for a PUCCH resource group per usage of a target PUCCH, i.e., for a SR PUCCH, an ACK/NACK PUCCH, a CSI PUCCH.

When a target RS/CH includes a SRS, a spatial parameter based on RS(s) of a corresponding reference TCI state may be applied to a spatial relation RS for a SRS resource per usage of a SRS (e.g., beam management (BM), codebook based (CB), Non-codebook based (non-CB), antenna switching (AS)) and/or per time domain characteristic of a SRS (e.g., periodic/semi-static/aperiodic).

When a target RS/CH includes a CSI-RS, a spatial parameter based on RS(s) of a corresponding reference TCI state may be applied to a spatial relation RS for a CSI-RS resource per usage of a CSI-RS (e.g., BM, TRS, CSI acquisition) and/or per time domain characteristic of a CSI-RS (e.g., periodic/semi-static/aperiodic).

when a TCI state is indicated for a CORESET ID for a specific CC through a MAC-CE, examples of embodiment 2-2 correspond to a method of changing/updating a spatial parameter of target RS(s)/CH(s) according to a BLS based on an indicated TCI state. In this case, similar to embodiment 2-1, based on an indicated TCI state, a UL/DL transmission or reception beam for target transmission or reception (i.e., a spatial parameter) may be determined according to a BLS configuration.

When a PDCCH is included in a target RS/CH in a configured BLS, activated TCI state(s) of all CORESET ID(s) including a CORESET ID indicated in a MAC-CE as described above may be changed/updated based on a QCL Type-D RS of a TCI state (i.e., a reference spatial parameter) changed/updated through the MAC-CE. Alternatively, although the indicated CORESET ID does not exist in specific BWP(s) of a specific CC, common spatial parameter application that activated TCI state(s) of the remaining CORESET ID(s) are changed/updated based on a TCI state, a reference spatial parameter, may be configured. Alternatively, when the indicated CORESET ID does not exist in specific BWP(s) of a specific CC, TCI state change/update for a CORESET may not be applied to corresponding BWP(s).

When a PDCCH is not included in a target RS/CH in a configured BLS and a CORESET ID indicated in a MAC-CE exists in BWP(s) of specific CC(s), a transmission or reception beam (i.e., a target spatial parameter) for UL/DL RS(s)/CH(s) may be updated according to a BLS while changing/updating a TCI state for the same CORESET ID as a corresponding CORESET ID in CC(s) in a CC list (or group or set).

When a PDCCH is not included in a target RS/CH in a configured BLS and a CORESET ID indicated in a MAC-CE does not exist in BWP(s) of specific CC(s), TCI state update may not be applied to corresponding BWP(s). Alternatively, for a lowest/highest CORESET ID or the remaining CORESET ID(s) excluding CORESET 0, a TCI state indicated in a MAC-CE may be applied by a predefined rule. Alternatively, a terminal may not expect that a CORESET ID other than CORESET ID(s) commonly configured for all BWP(s) in a CC is configured through a MAC-CE and may operate accordingly.

### Embodiment 3

This embodiment is about a method in which a target spatial parameter is determined based on a BLS for multiple CCs/BWPs when a reference spatial parameter is spatial relation info.

For example, a terminal may change/activate/indicate RS information for deriving a spatial Tx/Rx parameter for target RS(s)/CH(s) preconfigured by a BLS for other CC(s) belonging to a CC list (or group or set) that the specific CC is included by utilizing spatial relation info activated for a specific CC through simultaneous spatial parameter (e.g., relation info) update for an aperiodic (AP)/semi-static (SP) SRS. In other words, when a base station activates specific spatial relation info through simultaneous spatial parameter update to a terminal, a terminal may determine a transmission or reception spatial parameter for target RS(s)/CH(s) by using activated TCI state(s) (or based on activated TCI state(s)).

Spatial relation info subject to simultaneous spatial parameter update for multiple CCs/BWPs (i.e., a reference spatial parameter) may be equally/differently determined per CC/BWP.

As a first example, a spatial parameter for a target RS/CH may be changed to a RS included in indicated spatial relation info.

As a second example, the same spatial relation ID may be activated/indicated in corresponding CC(s).

In relation to activation of a spatial relation candidate group, all or part of spatial relation info (or a spatial relation RS of spatial relation info) may be activated as candidate(s) of QCL Type-D RS(s)/spatial relations RS(s) for target RS(s)/CH(s) of a BLS (i.e., a target spatial parameter). In this case, a QCL Type-D RS/spatial relation RS which will be applied to each target RS/CH transmission or reception may be separately indicated. Similarly, candidate(s) of a target spatial parameter may be also activated for other RS(s)/CH(s) liked by a BLS.

In relation to an indication of a specific spatial relation, a RS (e.g., a spatial relation RS) corresponding to one specific spatial relation info of activated spatial relation info(s) may be used as a RS for deriving a spatial Tx/Rx parameter for a target RS/CH (e.g., a QCL Type-D RS for a DL RS/CH, a spatial relation RS for a UL RS/CH). The one specific spatial relation info may be determined based on a predefined rule. When the one specific spatial relation info is determined, a resulting RS or indicator application method may change a spatial parameter for a target RS/CH to a RS included in indicated spatial relation info, or may follow the above-described example which activates/indicates the same spatial relation ID in corresponding CC(s).

For example, the one specific spatial relation info may be determined through a predefined rule (e.g., as spatial relation info having a lowest or highest ID).

As an additional example, the one specific spatial relation info may be determined as spatial relation info having a specific ID (e.g., an ID indicated through a MAC-CE) among activated spatial relation info(s).

As an additional example, when simultaneous spatial parameter update utilizing a BLS is enabled, spatial relation RS(s) may be equally determined as the one specific spatial relation info in each CC/BWP according to the number of resources in a CC/BWP set subject to simultaneous spatial parameter update.

In relation to a spatial relation application scope, when all or part of activated spatial relation info(s) are separately indicated as a spatial parameter which will be applied to target RS/CH transmission or reception or when one specific TCI state is determined, an application scope of RS(s) for corresponding spatial relation info (i.e., spatial relation info as a reference spatial parameter) may follow the following examples.

When a target RS/CH includes a PUCCH (or a SR PUCCH, an ACK/NACK PUCCH, a CSI PUCCH), a spatial parameter based on corresponding reference spatial relation RS(s) may be applied to a spatial relation RS for all PUCCH resources. Alternatively, a spatial parameter based on corresponding reference spatial relation RS(s) may be applied to a spatial relation RS for a PUCCH resource group per usage of a target PUCCH, i.e., for a SR PUCCH, an ACK/NACK PUCCH, a CSI PUCCH.

When a target RS/CH includes a SRS, a spatial parameter based on corresponding reference spatial relation RS(s) may be applied to a spatial relation RS for a SRS resource per usage of a SRS (e.g., BM, CB, non-CB, AS) and/or per time domain characteristic of a SRS (e.g., P/SP/AP). Alternatively, when spatial relation info is activated through a MAC-CE, a time domain characteristic of a SRS may be limited to a SP or AP SRS.

When a target RS/CH includes a CSI-RS, a spatial parameter based on corresponding reference spatial relation RS(s) may be applied to a spatial relation RS for a CSI-RS resource per usage of a CSI-RS (e.g., BM, TRS, CSI acquisition) and/or per time domain characteristic of a CSI-RS (e.g., periodic/semi-static/aperiodic). Alternatively, when spatial relation info is activated through a MAC-CE, a time domain characteristic of a CSI-RS may be limited to a SP or AP CSI-RS.

When a PDCCH is included in a target RS/CH indicated by a BLS for a CC/BWP where there is no CORESET configuration (e.g., a SCell having a DL CC scheduled in cross carrier scheduling), a BLS may be applied only to the remaining RS(s)/CH(s) excluding a PDCCH. Alternatively, a terminal may not expect to receive an indication on a BLS that a PDCCH is included for a CC/BWP where there is no CORESET configuration.

In BWP(s) of specific CC(s) in a CC list (or group or set), when a CORESET ID indicated by a MAC-CE does not exist and a PDCCH is not included in a target RS/CH indicated by a BLS, TCI state update may not be applied to corresponding BWP(s), or CORESET ID(s) may be selected according to a predefined rule (e.g., as a lowest or highest CORESET ID). Alternatively, a terminal may not expect that a CORESET ID other than CORESET ID(s) commonly configured for all BWP(s) in a CC is configured as a MAC-CE.

Examples of embodiment 3 may be applied when simultaneously changing/updating spatial relation info for a SP/AP SRS resource for multiple CCs/BWPs through a MAC-CE. For example, spatial relation info for a SP SRS may be included in an activation command for a SRS resource indicated through a MAC-CE. For example, spatial relation info for a AP SRS may be included in a spatial relation update command indicated through a MAC-CE. In this case, a SP/AP SRS resource set ID of a specific CC may be indicated through a MAC-CE and UL reference RS(s) may be configured according to the number of resources in a corresponding set.

First, all or part of activated spatial relation info(s) may be used as a candidate QCL Type-D RS or a candidate spatial relation RS for determining a spatial parameter of target RS(s)/CH(s) configured by a BLS. Here, a QCL Type-D RS/spatial relation RS which will be applied to each target RS/CH may be separately indicated.

For example, when a PUSCH is included in a target RS/CH in a configured BLS, a spatial relation RS which will be applied to actual PUSCH transmission may be separately indicated through DCI for a grant based PUSCH or through RRC/MAC-CE/DCI for a configured grant based PUSCH.

As an additional example, after indicating specific spatial relation info through a predefined rule for activated spatial relation info(s), a BLS based operation may be performed by using transmission beam information in the specific spatial relation info as a reference. Here, a predefined rule may be spatial relation info having a lowest or highest ID. In addition, in order to support a more dynamic spatial parameter indication, a spatial parameter of spatial relation info associated with a SRS resource indicated by a SRI field included in DCI may be determined as a reference spatial parameter.

When a SP/AP SRS resource set ID of a specific CC is indicated through a MAC-CE and UL reference RS(s) are separately indicated according to the number of resources in a corresponding set, spatial relation info for a UL reference RS may be configured as a reference spatial parameter for a BLS according to a predefined rule according to a corresponding resource index (e.g., as a lowest/highest index) and resulting target spatial parameter change/update may be performed.

As an additional example, based on an explicit rule, a RS index which will be utilized as a reference spatial parameter in a BLS based operation may be indicated among UL reference RS(s) activated by a MAC-CE.

As an additional example, when an enabler for a BLS based operation is configured as ‘ON’, a terminal may expect that a configuration of UL reference RS(s) according to the number of resources in a SRS resource set indicated through a MAC-CE will be the same.

As described above, when all or part of specific spatial relation info(s) are separately indicated as a QCL Type-D RS/a spatial relation RS which will be applied to a target RS/CH or when one specific spatial relation info is indicated, an application scope according to a BLS of a RS for corresponding spatial relation info may be implicitly/explicitly configured.

For example, a scheduling request (SR) means that a terminal requests a UL grant (e.g., DCI format 0 series) to a base station for PUSCH transmission. In this case, a terminal uses a SR PUCCH (e.g., PUCCH format 0 or PUCCH format 1) and a corresponding PUCCH resource may be configured by a higher layer parameter (e.g., a PUCCH-ResourceID (PRI) parameter of a SchedulingRequestResourceConfig information element of RRC). Accordingly, a transmission beam change/indication for a SR PUCCH based on a BLS may be applied to PUCCH resource(s) configured for a SR. Alternatively, a transmission beam change/indication based on a BLS may be applied to all resources for a PUCCH.

For example, for an ACK/NACK PUCCH, in case of DCI format 11, a transmission beam may be determined according to a 3-bit PRI field in a DCI field. A transmission beam change/indication based on a BLS may be applied to corresponding resources for an ACK/NACK PUCCH. Alternatively, a transmission beam change/indication based on a BLS may be applied to all resources for a PUCCH.

For example, for a PUCCH for periodic (P)/semi-static (SP) CSI report, a transmission beam change/indication based on a BLS may be applied to resource(s) for P/SP CSI report. Alternatively, a transmission beam change/indication based on a BLS may be applied to all resources for a PUCCH.

Accordingly, if a PUCCH for specific usage (e.g., a SR PUCCH/an A/N PUCCH/a CSI PUCCH) is configured when performing a PUCCH related configuration based on a BLS, a terminal may expect that a transmission beam is changed/indicated for PUCCH resource(s) for corresponding usage. Alternatively, when all resource(s) for a PUCCH are targeted, a terminal may expect that a transmission beam is changed/indicated based on a BLS for a PUCCH.

As an additional example, transmission beam change/update according to a BLS may be applied based on reference spatial relation info for resource(s) according to each usage, for resource(s) according to a time domain characteristic (P/SP/Aperiodic (AP)), or for resource(s) simultaneously considering usage and a time domain characteristic for a SRS or a CSI-RS.

For PUCCH spatial relation update through a MAC-CE, it indicates a UL reference RS for spatial relation info and a corresponding resource ID in a specific CC, so similar to a BLS based operation which applies a TCI state for a CORESET in embodiment 2-2 as a reference spatial parameter, based on a spatial relation RS of indicated PUCCH spatial relation info, a spatial parameter of RS(s)/CH(s) may be changed/updated according to a BLS.

For example, when a PDCCH is included in a target RS/CH in a configured BLS, activated TCI state(s) of all CORESET ID(s) of a CC indicated in a MAC-CE as described above may be changed/updated to a spatial reception parameter corresponding to a spatial transmission parameter through a spatial relation RS of spatial relation info changed/updated through the MAC-CE (i.e., a reference spatial parameter). Alternatively, although the indicated CORESET ID does not exist in specific BWP(s) of a specific CC, common spatial parameter application that activated TCI state(s) of the remaining CORESET ID(s) are changed/updated based on spatial relation info, a reference spatial parameter, may be configured. Alternatively, when the indicated CORESET ID does not exist in specific BWP(s) of a specific CC, TCI state change/update for a CORESET may not be applied to corresponding BWP(s).

FIG. 17 is a diagram for describing a signaling process according to an embodiment of the present disclosure.

An example of a signaling operation of a base station and a terminal for the above-described embodiments may be as in FIG. 17. Here, a terminal/a base station is just an example, and may be applied by being substituted with a variety of devices as described in FIG. 18. A base station may correspond to one base station including a plurality of TRPs or one cell including a plurality of TRPs. As FIG. 17 is for convenience of a description, it does not limit a scope of the present disclosure. In addition, some of steps described in FIG. 17 may be merged or omitted. In addition, the above-described downlink transmission or reception operation or uplink transmission or reception operation or a beam management operation may be applied in performing procedures described below, but a scope of the present disclosure is not limited thereto, and it may be applied to a variety of downlink reception or uplink transmission operations.

A base station may generally mean an object which performs transmission or reception of data with a terminal. For example, the base station may be a concept which includes at least one TP (Transmission Point), at least one TRP (Transmission or reception Point), etc. In addition, a TP and/or a TRP may also include a panel, a transmission or reception unit, etc. of a base station. In addition, “TRP” may be applied by being replaced with an expression such as a panel, an antenna array, a cell (e.g., a macro cell/a small cell/a pico cell, etc.), a TP (transmission point), a base station (base station, gNB, etc.), etc. As described above, a TRP may be classified according to information on a CORESET group (or a CORESET pool) (e.g., an index, an ID). In an example, when one terminal is configured to perform transmission or reception with multiple TRPs (or cells), it may mean that multiple CORESET groups (or CORESET pools) are configured for one terminal. Such a configuration for a CORESET group (or a CORESET pool) may be performed through higher layer signaling (e.g., RRC signaling, etc.).

UE may receive configuration information from a base station S105. The configuration may include system information (SI), scheduling information, a beam management (BM) related configuration (e.g., DL BM related CSI-ResourceConfig IE, NZP CSI-RS resource set IE, etc.), configuration information of a base station (e.g., a TRP configuration) and others. In addition, the configuration may include at least one of a CC/BWP related configuration, a CORESET related configuration and a default beam related configuration (e.g., a default TCI state, a default spatial relation, etc.). For example, the configuration may include information related to reconfiguration/update of RS information for a spatial relation (e.g., QCL relation) assumption (e.g., information related to whether to perform reconfiguration/update, a performance method, a time, etc.) In addition, the configuration may include beam linkage state (BLS) related configuration information. The configuration may be transmitted through higher layer (e.g., RRC or MAC CE) signaling. In addition, when the configuration is predefined or preconfigured, a corresponding step may be omitted.

For example, based on the above-described embodiments, the configuration may include information on at least one of TCI state(s), QCL RS(s), or DMRS port(s). For example, the TCI state may include RS information for a spatial relation (e.g., QCL relation) assumption. For example, the configuration may include spatial relation information/QCL relation configuration information for a DL channel (e.g., a PDCCH/a PDSCH) and/or an UL channel (e.g., a PUSCH/a PUCCH). For example, as described in the above-described embodiments, the configuration may include a linkage relation configuration (e.g., BLS information) between reference transmission or reception (e.g., a reference RS/CH) and target transmission or reception (e.g., a target RS/CH). For example, the configuration may include QCL related information (e.g., RS information for a spatial relation assumption, etc.) of a downlink channel (e.g., a PDCCH/a PDSCH) and/or information indicating change/update for a linkage relation configuration (e.g., a BLS). For example, the configuration may include beam linkage state (BLS) information (e.g., a relation/a scope/a configuration, etc. between a reference spatial parameter and a target spatial parameter), simultaneous spatial parameter update operation activation information for multiple CCs/BWPs (e.g., an enabler), etc.

For example, the above-described operation that UE (100/200 in FIG. 18) in S105 receives the configuration from a base station (200/100 in FIG. 18) may be implemented by a device in FIG. 18 which will be described after. For example, in reference to FIG. 18, at least one processor 102 may control at least one transceiver 106 and/or at least one memory 104, etc. to receive the configuration and at least one transceiver 106 may receive the configuration from a base station.

UE may receive control information from a base station S110. The control information may be received through a control channel (e.g., a PDCCH). In an example, the control information may be DCI/UCI. For example, the control information may include scheduling information for a downlink data channel (e.g., a PDSCH) and/or an uplink channel (e.g., a PUCCH/a PUSCH), etc. For example, based on the above-described embodiments, the control information may include information on at least one of TCI state(s), QCL RS(s), or DMRS port(s). For example, at least one TCI state may be indicated for DMRS port(s) related to a DL data channel (e.g., a PDSCH)/an UL channel (e.g., a PUCCH/a PUSCH) by a TCI state field in the control information (e.g., DCI). For example, the TCI state may include RS information for a spatial relation (e.g., QCL relation) assumption.

For example, the above-described operation that UE (100/200 in FIG. 18) in S110 receives the control information from a base station (200/100 in FIG. 18) may be implemented by a device in FIG. 18 which will be described below. For example, in reference to FIG. 18, at least one processor 102 may control at least one transceiver 106 and/or at least one memory 104, etc. to receive the control information and at least one transceiver 106 may receive the control information from a base station.

UE may receive data from a base station or may transmit data to a base station S115. The data may be received through a downlink channel (e.g., a PDCCH/a PDSCH) or may be transmitted through an uplink channel (e.g., a PUCCH/a PUSCH/a PRACH). In addition, the data may be a downlink signal (e.g., a SSB/a CSI-RS) or may be an uplink signal (e.g., a SRS). For example, the data may be scheduled based on the control information. In addition, the data may be received based on information configured/indicated in S105/S110. For example, UE may perform channel estimation/compensation and receive the data based on information configured/indicated in S105/S110. For example, based on the above-described embodiments, a spatial relation related RS for receiving the data (e.g., a QCL type D RS) may be configured. For example, a spatial relation related RS (of a downlink channel) for receiving the data (e.g., a QCL type D RS) may be configured/changed based on spatial relation information of an uplink channel transmitted by UE (e.g., a PUCCH/a PUSCH). For example, a spatial relation related RS (of a downlink channel) for receiving the data (e.g., a QCL type D RS) may be configured based on usage/contents of the uplink channel (e.g., SR, HARQ-ACK/NACK, CSI, etc.).

For example, a spatial relation related RS (of a downlink channel) for receiving the data (e.g., a QCL type D RS) may be configured/updated/changed per CORESET/search space (SS). For example, based on whether a TCI field is included/exists in DCI, whether to apply a QCL RS indicated in a TCI or whether to follow spatial relation info of an uplink channel may be determined. For example, reference spatial parameter information (e.g., a reference TCI state ID) which is a reference for change/update may be configured/indicated based on the configuration/control information and may be transmitted and received by applying target spatial parameter information corresponding to a reference spatial parameter to a target RS/CH/Data configured through a BLS, i.e., associated with reference transmission or reception.

For example, the above-described operation that UE (100/200 in FIG. 18) in S115 receives the data from a base station (200/100 in FIG. 18) may be implemented by a device in FIG. 18 which will be described after. For example, in reference to FIG. 18, at least one processor 102 may control at least one transceiver 106 and/or at least one memory 104, etc. to receive the data and at least one transceiver 106 may receive the data from a base station.

It was not shown in FIG. 17, but UE may report to a base station whether a QCL reference RS of a DL channel (e.g., a PDCCH/a PDSCH) was changed/updated based on a transmission beam (/QCL relation RS) of an UL channel.

Of course, in an example of FIG. 17, examples of the present disclosure (e.g., embodiment 1, embodiment 2, embodiment 3, etc.) may be applied to an uplink transmission operation. For example, uplink data transmission may be performed through an uplink channel (e.g., a PUCCH/a PUSCH). For example, uplink data may include SRS/CSI report/HARQ-ACK/SR, etc. For example, a reference spatial parameter (e.g., a reference TCI state ID) which is a reference for change/update may be configured/indicated based on the configuration/control information and uplink data may be transmitted by applying target spatial parameter information corresponding to a reference spatial parameter to a target RS/CH/Data configured by a BLS, i.e., associated with reference transmission or reception. For example, for BLS information which is preconfigured through higher layer signaling, a spatial TX/RX parameter which will be applied to uplink transmission may be changed/updated based on update information indicated/configured through a MAC-CE/DCI, etc. In an example, the update information indicated/configured through a MAC-CE/DCI, etc. may be spatial relation update information for an AP/SP SRS.

As described above, the above-described base station/UE signaling and operation (e.g., embodiment 1, embodiment 2, embodiment 3, FIG. 15, FIG. 16, FIG. 17, etc.) may be implemented by a device which will be described after (e.g., FIG. 18). For example, a base station may correspond to a first wireless device and UE may correspond to a second wireless device and in some cases, the opposite may be considered.

For example, the above-described base station/UE signaling and operation (e.g., embodiment 1, embodiment 2, embodiment 3, FIG. 15, FIG. 16, FIG. 17, etc.) may be processed by at least one processor in FIG. 18 (e.g., 102, 202) and the above-described base station/UE signaling and operation (e.g., embodiment 1, embodiment 2, embodiment 3, FIG. 15, FIG. 16, FIG. 17, etc.) may be stored in a memory (e.g., at least one memory in FIG. 18 (e.g., 104, 204)) in a form of a command/a program (e.g., an instruction, an executable code) for driving at least one processor in FIG. 18 (e.g., 102, 202).

General Device to which the Present Disclosure May be Applied

FIG. 18 is a diagram which illustrates a block diagram of a wireless communication system according to an embodiment of the present disclosure.

In reference to FIG. 18, a first wireless device 100 and a second wireless device 200 may transmit and receive a wireless signal through a variety of radio access technologies (e.g., LTE, NR).

A first wireless device 100 may include one or more processors 102 and one or more memories 104 and may additionally include one or more transceivers 106 and/or one or more antennas 108. A processor 102 may control a memory 104 and/or a transceiver 106 and may be configured to implement description, functions, procedures, proposals, methods and/or operation flow charts included in the present disclosure. For example, a processor 102 may transmit a wireless signal including first information/signal through a transceiver 106 after generating first information/signal by processing information in a memory 104. In addition, a processor 102 may receive a wireless signal including second information/signal through a transceiver 106 and then store information obtained by signal processing of second information/signal in a memory 104. A memory 104 may be connected to a processor 102 and may store a variety of information related to an operation of a processor 102. For example, a memory 104 may store a software code including commands for performing all or part of processes controlled by a processor 102 or for performing description, functions, procedures, proposals, methods and/or operation flow charts included in the present disclosure. Here, a processor 102 and a memory 104 may be part of a communication modem/circuit/chip designed to implement a wireless communication technology (e.g., LTE, NR). A transceiver 106 may be connected to a processor 102 and may transmit and/or receive a wireless signal through one or more antennas 108. A transceiver 106 may include a transmitter and/or a receiver. A transceiver 106 may be used together with a RF (Radio Frequency) unit. In the present disclosure, a wireless device may mean a communication modem/circuit/chip.

A second wireless device 200 may include one or more processors 202 and one or more memories 204 and may additionally include one or more transceivers 206 and/or one or more antennas 208. A processor 202 may control a memory 204 and/or a transceiver 206 and may be configured to implement description, functions, procedures, proposals, methods and/or operation flows charts included in the present disclosure. For example, a processor 202 may generate third information/signal by processing information in a memory 204, and then transmit a wireless signal including third information/signal through a transceiver 206. In addition, a processor 202 may receive a wireless signal including fourth information/signal through a transceiver 206, and then store information obtained by signal processing of fourth information/signal in a memory 204. A memory 204 may be connected to a processor 202 and may store a variety of information related to an operation of a processor 202. For example, a memory 204 may store a software code including commands for performing all or part of processes controlled by a processor 202 or for performing description, functions, procedures, proposals, methods and/or operation flow charts included in the present disclosure. Here, a processor 202 and a memory 204 may be part of a communication modem/circuit/chip designed to implement a wireless communication technology (e.g., LTE, NR). A transceiver 206 may be connected to a processor 202 and may transmit and/or receive a wireless signal through one or more antennas 208. A transceiver 206 may include a transmitter and/or a receiver. A transceiver 206 may be used together with a RF unit. In the present disclosure, a wireless device may mean a communication modem/circuit/chip.

Hereinafter, a hardware element of a wireless device 100, 200 will be described in more detail. It is not limited thereto, but one or more protocol layers may be implemented by one or more processors 102, 202. For example, one or more processors 102, 202 may implement one or more layers (e.g., a functional layer such as PHY, MAC, RLC, PDCP, RRC, SDAP). One or more processors 102, 202 may generate one or more PDUs (Protocol Data Unit) and/or one or more SDUs (Service Data Unit) according to description, functions, procedures, proposals, methods and/or operation flow charts included in the present disclosure. One or more processors 102, 202 may generate a message, control information, data or information according to description, functions, procedures, proposals, methods and/or operation flow charts included in the present disclosure. One or more processors 102, 202 may generate a signal (e.g., a baseband signal) including a PDU, a SDU, a message, control information, data or information according to functions, procedures, proposals and/or methods disclosed in the present disclosure to provide it to one or more transceivers 106, 206. One or more processors 102, 202 may receive a signal (e.g., a baseband signal) from one or more transceivers 106, 206 and obtain a PDU, a SDU, a message, control information, data or information according to description, functions, procedures, proposals, methods and/or operation flow charts included in the present disclosure.

One or more processors 102, 202 may be referred to as a controller, a micro controller, a micro processor or a micro computer. One or more processors 102, 202 may be implemented by a hardware, a firmware, a software, or their combination. In an example, one or more ASICs (Application Specific Integrated Circuit), one or more DSPs (Digital Signal Processor), one or more DSPDs (Digital Signal Processing Device), one or more PLDs (Programmable Logic Device) or one or more FPGAs (Field Programmable Gate Arrays) may be included in one or more processors 102, 202. Description, functions, procedures, proposals, methods and/or operation flow charts included in the present disclosure may be implemented by using a firmware or a software and a firmware or a software may be implemented to include a module, a procedure, a function, etc. A firmware or a software configured to perform description, functions, procedures, proposals, methods and/or operation flow charts included in the present disclosure may be included in one or more processors 102, 202 or may be stored in one or more memories 104, 204 and driven by one or more processors 102, 202. Description, functions, procedures, proposals, methods and/or operation flow charts included in the present disclosure may be implemented by using a firmware or a software in a form of a code, a command and/or a set of commands.

One or more memories 104, 204 may be connected to one or more processors 102, 202 and may store data, a signal, a message, information, a program, a code, an instruction and/or a command in various forms. One or more memories 104, 204 may be configured with ROM, RAM, EPROM, a flash memory, a hard drive, a register, a cash memory, a computer readable storage medium and/or their combination. One or more memories 104, 204 may be positioned inside and/or outside one or more processors 102, 202. In addition, one or more memories 104, 204 may be connected to one or more processors 102, 202 through a variety of technologies such as a wire or wireless connection.

One or more transceivers 106, 206 may transmit user data, control information, a wireless signal/channel, etc. mentioned in methods and/or operation flow charts, etc. of the present disclosure to one or more other devices. One or more transceivers 106, 206 may receiver user data, control information, a wireless signal/channel, etc. mentioned in description, functions, procedures, proposals, methods and/or operation flow charts, etc. included in the present disclosure from one or more other devices. For example, one or more transceivers 106, 206 may be connected to one or more processors 102, 202 and may transmit and receive a wireless signal. For example, one or more processors 102, 202 may control one or more transceivers 106, 206 to transmit user data, control information or a wireless signal to one or more other devices. In addition, one or more processors 102, 202 may control one or more transceivers 106, 206 to receive user data, control information or a wireless signal from one or more other devices. In addition, one or more transceivers 106, 206 may be connected to one or more antennas 108, 208 and one or more transceivers 106, 206 may be configured to transmit and receive user data, control information, a wireless signal/channel, etc. mentioned in description, functions, procedures, proposals, methods and/or operation flow charts, etc. included in the present disclosure through one or more antennas 108, 208. In the present disclosure, one or more antennas may be a plurality of physical antennas or a plurality of logical antennas (e.g., an antenna port). One or more transceivers 106, 206 may convert a received wireless signal/channel, etc. into a baseband signal from a RF band signal to process received user data, control information, wireless signal/channel, etc. by using one or more processors 102, 202. One or more transceivers 106, 206 may convert user data, control information, a wireless signal/channel, etc. which are processed by using one or more processors 102, 202 from a baseband signal to a RF band signal. Therefore, one or more transceivers 106, 206 may include an (analogue) oscillator and/or a filter.

Embodiments described above are that elements and features of the present disclosure are combined in a predetermined form. Each element or feature should be considered to be optional unless otherwise explicitly mentioned. Each element or feature may be implemented in a form that it is not combined with other element or feature. In addition, an embodiment of the present disclosure may include combining a part of elements and/or features. An order of operations described in embodiments of the present disclosure may be changed. Some elements or features of one embodiment may be included in other embodiment or may be substituted with a corresponding element or a feature of other embodiment. It is clear that an embodiment may include combining claims without an explicit dependency relationship in claims or may be included as a new claim by amendment after application.

It is clear to a person skilled in the pertinent art that the present disclosure may be implemented in other specific form in a scope not going beyond an essential feature of the present disclosure. Accordingly, the above-described detailed description should not be restrictively construed in every aspect and should be considered to be illustrative. A scope of the present disclosure should be determined by reasonable construction of an attached claim and all changes within an equivalent scope of the present disclosure are included in a scope of the present disclosure.

A scope of the present disclosure includes software or machine-executable commands (e.g., an operating system, an application, a firmware, a program, etc.) which execute an operation according to a method of various embodiments in a device or a computer and a non-transitory computer-readable medium that such a software or a command, etc. are stored and are executable in a device or a computer. A command which may be used to program a processing system performing a feature described in the present disclosure may be stored in a storage medium or a computer-readable storage medium and a feature described in the present disclosure may be implemented by using a computer program product including such a storage medium. A storage medium may include a high-speed random-access memory such as DRAM, SRAM, DDR RAM or other random-access solid state memory device, but it is not limited thereto, and it may include a nonvolatile memory such as one or more magnetic disk storage devices, optical disk storage devices, flash memory devices or other nonvolatile solid state storage devices. A memory optionally includes one or more storage devices positioned remotely from processor(s). A memory or alternatively, nonvolatile memory device(s) in a memory include a non-transitory computer-readable storage medium. A feature described in the present disclosure may be stored in any one of machine-readable mediums to control a hardware of a processing system and may be integrated into a software and/or a firmware which allows a processing system to interact with other mechanism utilizing a result from an embodiment of the present disclosure. Such a software or a firmware may include an application code, a device driver, an operating system and an execution environment/container, but it is not limited thereto.

Here, a wireless communication technology implemented in a wireless device 100, 200 of the present disclosure may include Narrowband Internet of Things for a low-power communication as well as LTE, NR and 6G. Here, for example, an NB-IoT technology may be an example of a LPWAN (Low Power Wide Area Network) technology, may be implemented in a standard of LTE Cat NB1 and/or LTE Cat NB2, etc. and is not limited to the above-described name. Additionally or alternatively, a wireless communication technology implemented in a wireless device 100, 200 of the present disclosure may perform a communication based on a LTE-M technology. Here, in an example, a LTE-M technology may be an example of a LPWAN technology and may be referred to a variety of names such as an eMTC (enhanced Machine Type Communication), etc. For example, an LTE-M technology may be implemented in at least any one of various standards including 1) LTE CAT 0, 2) LTE Cat M1, 3) LTE Cat M2, 4) LTE non-BL (non-Bandwidth Limited), 5) LTE-MTC, 6) LTE Machine Type Communication, and/or 7) LTE M and so on and it is not limited to the above-described name. Additionally or alternatively, a wireless communication technology implemented in a wireless device 100, 200 of the present disclosure may include at least any one of a ZigBee, a Bluetooth and a low power wide area network (LPWAN) considering a low-power communication and it is not limited to the above-described name. In an example, a ZigBee technology may generate PAN (personal area networks) related to a small/low-power digital communication based on a variety of standards such as IEEE 802.15.4, etc. and may be referred to as a variety of names.

### INDUSTRIAL APPLICABILITY

A method proposed by the present disclosure is mainly described based on an example applied to 3GPP LTE/LTE-A, 5G system, but may be applied to various wireless communication systems other than the 3GPP LTE/LTE-A, 5G system.

1. A method of performing uplink transmission or downlink reception by a terminal in a wireless communication system, the method comprising:
receiving from a base station configuration information on a first beam linkage state (BLS) for a first resource and a second BLS for a second resource, wherein each of the first and second BLS includes information on a mapping relation between reference transmission or reception and at least one target transmission or reception;
receiving from the base station reference spatial parameter indication information for the reference transmission or reception for the first resource; and
based on a target spatial parameter for specific target transmission or reception among the at least one target transmission or reception, performing the uplink transmission or the downlink reception on the second resource,
wherein the target spatial parameter is determined based on the reference spatial parameter.

2. The method according to claim 1, wherein:
the indication information indicates the reference spatial parameter for the reference transmission or reception which is simultaneously applied to the first resource and the second resource.

3. The method according to claim 1, wherein:
the specific target transmission or reception is the target transmission or reception mapped to the reference transmission or reception based on the second BLS.

4. The method according to claim 1, wherein:
the target spatial parameter is a spatial parameter corresponding to the reference spatial parameter for the second resource.

5. The method according to claim 1, wherein:
the first BLS and the second BLS are same or different.

6. The method according to claim 1, wherein:
the first BLS and the second BLS are based on a BLS configured for a third resource among a resource group to which the first resource or the second resource belongs.

7. The method according to claim 1, wherein:
at least one target spatial parameter candidate corresponding to the reference spatial parameter is determined,
one specific target spatial parameter is determined among the at least one target spatial parameter candidate.

8. The method according to claim 7, wherein:
the one specific target spatial parameter is determined as a spatial parameter corresponding to a lowest or highest identifier or is determined as the spatial parameter indicated by downlink control information (DCI) related to the uplink transmission or the downlink transmission.

9. The method according to claim 1, wherein:
based on the reference transmission or reception being predetermined downlink reception, the reference spatial parameter is indicated by a transmission configuration indicator (TCI).

10. The method according to claim 1, wherein:
based on the reference transmission or reception being predetermined uplink transmission, the reference spatial parameter is indicated by spatial relation info.

11. The method according to claim 1, wherein:
the reference transmission or reception or the target transmission or reception is configured based on at least one of a predetermined uplink or downlink reference signal (RS), a predetermined uplink or downlink physical channel, and a predetermined uplink transmission or downlink reception type.

12. The method according to claim 11, wherein:
the predetermined uplink transmission or downlink reception type is defined based on at least one of usage, contents, a format, a type or a time domain characteristic of the predetermined uplink transmission or downlink reception.

13. The method according to claim 1, wherein:
information on whether the uplink transmission or the downlink reception is performed based on the BLS is provided from the base station.

14. The method according to claim 1, wherein:
a corresponding relation between the reference spatial parameter and the target spatial parameter is predetermined.

15. The method according to claim 1, wherein:
the resource is configured based on at least one of a component carrier (CC), a CC list, a bandwidth part (BWP), or a band configured for the terminal.

16. A terminal for performing uplink transmission or downlink reception in a wireless communication system, the terminal comprising:
at least one transceiver; and
at least one processor connected to the at least one transceiver,
wherein the at least one processor is configured to:
receive, from the base station through the at least one transceiver, configuration information on a first beam linkage state (BLS) for a first resource and a second BLS for a second resource, wherein each of the first and second BLS includes information on a mapping relation between reference transmission or reception and at least one target transmission or reception;
receive, from the base station through the at least one transceiver, reference spatial parameter indication information for the reference transmission or reception for the first resource; and
perform, through the at least one transceiver, the uplink transmission or the downlink reception on the second resource based on a target spatial parameter for specific target transmission or reception among the at least one target transmission or reception,
wherein the target spatial parameter is determined based on the reference spatial parameter.

17. (canceled)

18. A base station for performing a downlink transmission or uplink reception in a wireless communication system, the base station comprising:
at least one transceiver; and
at least one processor connected to the at least one transceiver,
wherein the at least one processor is configured to:
transmit, through the at least one transceiver to a terminal, configuration information on a first beam linkage state (BLS) for a first resource and a second BLS for a second resource, wherein each of the first and second BLS includes information on a mapping relation between reference transmission or reception and at least one target transmission or reception;
transmit, through the at least one transceiver to the terminal, reference spatial parameter indication information for the reference transmission or reception for the first resource; and
perform, through the at least one transceiver, the downlink transmission or the uplink reception on the second resource,
wherein the downlink transmission or the uplink reception on the second resource is received or transmitted by the terminal based on a target spatial parameter for specific target transmission or reception among the at least one target transmission or reception,
wherein the target spatial parameter is determined based on the reference spatial parameter.

19-20. (canceled)
